(19) United States
(12) Patent Application Publication
(10) Pub. No.: US 2024/0253119 A1
(43) Pub. Date: Aug. 1, 2024

(54) A METHOD FOR A PRESS APPARATUS AND A RELATED SYSTEM

(71) Applicant: Quintus Technologies AB, Västerås (SE)

(72) Inventors: Per Burström, Västerås (SE); Johannes Gårdstam, Västerås (SE); Magnus Ahlfors, Västerås (SE)

(73) Assignee: Quintus Technologies AB, Västerås (SE)

(21) Appl. No.: 18/561,162

(22) PCT Filed: Jun. 11, 2021
(86) PCT No.: PCT/EP2021/065846

§ 371 Date: Nov. 15, 2023

(51) Int. Cl. B22F 3/15

(52) U.S. Cl. CPC B22F 3/15; B22F 2003/153; B22F 2998/10

(57) ABSTRACT

A method for a press apparatus is disclosed. The press apparatus comprises a pressure vessel including a heat insulated casing, within which at least one article is arrangeable. The press apparatus is configured to subject at least one article, which is or can be arranged within the heat insulated casing, to treatment. The method comprises, prior to carrying out the treatment of the at least one article using the press apparatus, heating at least a part or portion of the heat insulated casing using at least one heating means such that any amount of moisture present in or on the at least a part or portion of the heat insulated casing is reduced. Subsequently to the heating of the at least a part or portion of the heat insulated casing, the treatment of the at least one article using the press apparatus is carried out.

### TECHNICAL FIELD

The present invention generally relates to the field of high-pressure technology, in particular pressure treatment. More specifically, the present invention relates to a method for a press apparatus for treatment of at least one article, for example by means of isostatic pressing such as hot isostatic pressing (HIP). The present invention further relates to a system that is related to the method.

### BACKGROUND

Hot isostatic pressing (HIP) employs a pressure medium in form of a pressurized heated gas to achieve for example consolidation, densification, or bonding of high-performance components and materials. HIP may for example be used for reducing or even eliminating porosity in processed articles, achieving 100% of maximum theoretical density in process articles such as castings (e.g., turbine blades), resulting in exceptional resistance to fatigue, impact, wear and abrasion. HIP may in addition be used in manufacturing of products by means of compressing powder (which may be referred to as powder metallurgy HIP, or PM HIP), which products are desired or required to be fully, or substantially fully, dense, and to have pore-free, or substantially pore-free, outer surfaces, etc. The products obtained from HIP processing may for example be used in airplane bodies, aviation engines, car engines, human-body implants, and in the offshore industry, just to mention some applications. HIP provides many benefits and has become a viable and high-performance alternative and/or complement to conventional processes such as forging, casting and machining. An article to be subjected to pressure treatment by HIP may be positioned in a load compartment or chamber of a thermally insulated pressure vessel. A treatment cycle may comprise loading the article, treating the article, and unloading the article. Several articles may be treated simultaneously. The treatment cycle may be divided into several parts, or phases, such as a pressing phase, a heating phase, and a cooling phase. After loading an article into the pressure vessel, it may then be sealed, followed by introduction of a pressure medium (e.g., comprising an inert gas such as Argon-containing gas) into the pressure vessel and the load compartment thereof. The pressure and temperature of the pressure medium is then increased, such that the article is subjected to an increased pressure and an increased temperature during a selected period of time. The increase in temperature of the pressure medium, which in turn may cause an increase in temperature of the article, is provided by means of a heating element or furnace arranged in a furnace chamber of the pressure vessel. The pressures, temperatures and treatment times may for example depend on the desired or required material properties of the treated article, the particular field of application, and the required quality of the treated article. Pressures in HIP may for example be in the range from 200 bar to 5000 bar, such as from 800 bar to 2000 bar. Temperatures in HIP may for example be in the range from 300° C. to 3000° C., such as from 800° C. to 2000° C.

### SUMMARY

Any impurities in the pressure medium used in isostatic pressing such as HIP, e.g., impurities in the form of water, nitrogen or oxygen, may have a harmful effect on treated articles, in particular on articles made of materials with high reactivity to these impurities, e.g., so-called superalloys. The impurities may chemically react with the surface of the articles and create a surface layer with a different chemistry than the original material of the articles. Such surface layer may for example comprise oxides and/or nitrides, for example chromium oxides, aluminium oxides and/or titanium nitrides. Such surface layer may have a negative influence on the surface properties of the articles that may be detrimental to material properties of the articles such as toughness, strength, fatigue and corrosion properties. Such surface layers may also have a negative influence in any subsequent process steps in the manufacturing such as a surface coating process. Such surface layers may change the colour of the articles and may in the following be referred to as discolorations (on the articles). Such surface layers or discolorations may have to be removed from the articles. The removal of discoloration(s) from the articles may increase the number of operations needed for treating the articles, thereby possibly increasing costs associated with the treatment.

The impurities present in the pressure medium during the treatment may instead of forming a surface reaction or in addition to forming a surface reaction also diffuse into the interior of the articles and thus modify the chemistry of the material of the articles. Such a modification of the chemistry ever so slightly may also have a negative influence on the properties of the articles.

In view of the above, a concern of the present invention is to provide a way for reducing the amount of impurities or even avoiding any impurities in the pressure medium used in a press apparatus for treatment, for example for isostatic pressing such as HIP.

A further concern of the present invention is to provide a way for keeping the costs associated with treatment, for example isostatic pressing such as HIP, relatively low.

To address at least one of these concerns and other concerns, a method and a system in accordance with the independent claims are provided. Preferred embodiments are defined by the dependent claims.

The inventors have found that one of the main reasons, or possibly even the main reason, for any discolorations on treated articles is water vapor (or steam) in the pressure medium, which water vapor may originate from moisture that may be present in or on the so called mantle of the press apparatus. Other reasons might include water vapor that may already be present in the pressure medium when supplying the pressure medium to the pressure apparatus (e.g., from a pressure medium source), and water vapor that may originate from moisture that may be present in or on the article(s) to be treated. The mantle may be arranged or arrangeable in a pressure vessel of the press apparatus. The mantle may possibly be referred to as a heat insulated casing. The mantle is arranged such that pressure medium can enter into and also exit an interior of the mantle. The interior of the mantle comprises one or more cavities that are arranged to accommodate the article(s) to be treated. The cavity or cavities may be referred to as a load compartment. The mantle may have heat insulated walls, e.g., heat insulated outer walls. The mantle may be removably arranged in the press apparatus, such that the mantle can be at least temporarily removed from the press apparatus, for example in order to place, replace or remove article(s) in/from the interior of the mantle. Prior to carrying out treatment using the press apparatus, the mantle may be arranged outside the pressure vessel, where it may be exposed to the ambient air, e.g., at the site where the press apparatus is installed, for an extended period of time (e.g., for several hours, or overnight). It has been found by the inventors that—for example during such an extended period of time when the mantle is arranged outside the pressure vessel and exposed to the ambient air—there may be a tendency for moisture originating from the ambient air to accumulate in or on heat insulation material that may be included in the mantle (e.g., in the outer walls thereof), and further that accumulation of moisture in or on heat insulation material that may be included in the mantle may be of the main reasons, or possibly even the main reason, for accumulation of moisture in the pressure vessel. There could be a significant accumulation of moisture originating from the ambient air in or on heat insulation material that may be included in the mantle also during shorter periods of time (e.g., during the time it takes for opening the pressure vessel and unloading articles having been treated in the press apparatus and loading new articles to be treated in the press apparatus) in case there is a high level of humidity in the ambient air. There could also be accumulation of moisture in or on another or other parts of the mantle. Also, accumulation of moisture in or on the mantle may occur not only if the mantle is temporarily arranged outside the pressure vessel, but possibly also if the mantle would be arranged in the pressure vessel and the pressure vessel is open for an extended period of time (e.g., for several hours, or overnight). If there would be significant amounts of moisture present in or on the heat insulated casing of the press apparatus prior to carrying out treatment using the press apparatus, the moisture may during the treatment (e.g., at the beginning of the treatment) cause a build-up of water vapor in the pressure medium used in the press apparatus for carrying out the treatment. If the fraction of water vapor in the pressure medium during treatment is high enough, the water vapor in the pressure medium may cause undesired surface layers (discolorations) to be formed on the treated articles. This problem generally becomes more pronounced the higher the pressure (in the pressure vessel) is at which the treatment is carried out. In general, the higher the pressure at which the treatment is carried out, the smaller the fraction of water vapor in the pressure medium must be in order for coatings not to be formed on the treated articles. The problem also depends on the material of the articles to be treated. For each material and given a specific pressure at which the treatment is carried out, there may be a threshold fraction of water vapor in the pressure medium above which coatings are formed on the treated articles. It has been found by the inventors that different materials may have different threshold fractions of water vapor in the pressure medium above which coatings are formed on the treated articles. For example, the following materials are ordered according to ascending threshold fractions of water vapor in the pressure medium above which coatings are formed on the treated articles: nickel-base alloys, stainless steel, titan, cobalt-chrome, steel. Thus, coatings may for example be formed on the treated articles more easily for nickel-based articles, e.g., articles made of nickel-base alloys containing for example chromium and/or aluminium, than for steel-based articles. The fact that there may, for each material and given a specific pressure at which the treatment is carried out, be a threshold fraction of water vapor in the pressure medium above which coatings are formed on the treated articles, is illustrated in FIG. 1. FIG. 1 is schematic graphs of the fraction of water vapor in the pressure medium at atmospheric pressure C as a function of pressure P at which the treatment is carried out, for different types of materials. Each of the graphs in FIG. 1, denoted c1, c2, c3, c4 and c5, is for a different material. In FIG. 1, the pressure P at which the treatment is carried out is shown on the horizontal axis, and the fraction of water vapor in the pressure medium at atmospheric pressure C is shown on the vertical axis. According to one example, the graphs c1, c2, c3, c4 and c5 represent a nickel-based material, stainless steel, titan, cobalt-chrome, and steel, respectively. The positions in FIG. 1 where the respective ones of the graphs c1, c2, c3, c4 and c5 cross with the vertical dashed line represent the threshold fraction of water vapor in the pressure medium above which coatings are formed on the treated articles, for the nickel-based material, stainless steel, titan, cobalt-chrome, and steel, respectively, at an example pressure of 1000 bar.

According to a first aspect of the present invention, a method for a press apparatus is provided. According to a second aspect of the present invention, a system is provided. The method and the system according to the first and second aspects of the present invention are generally directed to heating the mantle, or heat insulated casing, prior to carrying out treatment using the press apparatus, such that any moisture that may be present in or on the mantle or heat insulated casing is reduced.

The press apparatus in accordance with the first aspect of the present invention may comprise a pressure vessel, which may be arranged to hold pressure medium therein during use of the press apparatus. The pressure vessel may comprise an end closure. There may be a first end closure and a second end closure comprised in the pressure vessel. For example in case the pressure vessel is arranged upright (e.g., such that a length direction of the pressure vessel is along a vertical direction), the first end closure and the second end closure could be referred to as an upper, or top, end closure and a lower end closure. The press apparatus may comprise a heat insulated casing arranged within the pressure vessel. The heat insulated casing may at least partly enclose a furnace chamber. The heat insulated casing may be arranged so that pressure medium can enter and exit the furnace chamber. The heat insulated casing may comprise a heat insulating portion, which may at least partly enclose the furnace chamber, and a housing, which may at least partly enclose the heat insulating portion. A treatment region, arranged to accommodate at least one article, may be at least in part defined by the furnace chamber. The press apparatus may be configured to subject the at least one article to treatment. The heat insulated casing may comprise at least one pressure medium guiding passage, which may be formed between at least a portion of the housing and at least a portion of the heat insulating portion. The at least one pressure medium guiding passage may be arranged to, during use of the press apparatus, guide pressure medium that has exited the furnace chamber towards the end closure such that pressure medium having exited the at least one pressure medium guiding passage can be guided in proximity to an inner surface of a wall of the pressure vessel.

The method according to the first aspect of the present invention may comprise, prior to carrying out the treatment of the at least one article using the press apparatus, heating at least a part or portion of the heat insulated casing using at least one heating means such that any amount of moisture present in or on the at least a part or portion of the heat insulated casing is reduced. The method according to the first aspect of the present invention may comprise, subsequently to the heating of the at least a part or portion of the heat insulated casing, carrying out the treatment of the at least one article using the press apparatus.

According to a second aspect of the present invention, a system is provided. The system may comprise a press apparatus. The press apparatus in accordance with the second aspect of the present invention may be the same or similar as the press apparatus in accordance with the first aspect of the present invention. Accordingly, the press apparatus in accordance with the second aspect of the present invention may comprise a pressure vessel, which may be arranged to hold pressure medium therein during use of the press apparatus. The pressure vessel may comprise an end closure. The press apparatus may comprise a heat insulated casing arranged within the pressure vessel. The heat insulated casing may at least partly enclose a furnace chamber. The heat insulated casing may be arranged so that pressure medium can enter and exit the furnace chamber. The heat insulated casing may comprise a heat insulating portion, which may at least partly enclose the furnace chamber, and a housing, which may at least partly enclose the heat insulating portion. A treatment region, arranged to accommodate at least one article, may be at least in part defined by the furnace chamber. The press apparatus may be configured to subject the at least one article to treatment. The heat insulated casing may comprise at least one pressure medium guiding passage, which may be formed between at least a portion of the housing and at least a portion of the heat insulating portion, respectively. The at least one pressure medium guiding passage may be arranged to, during use of the press apparatus, guide pressure medium that has exited the furnace chamber towards the end closure such that pressure medium having exited the at least one pressure medium guiding passage can be guided in proximity to an inner surface of a wall of the pressure vessel.

The system according to the second aspect of the present invention may comprise at least one heating means. The at least one heating means may be configured to, prior to carrying out the treatment of the at least one article using the press apparatus, heat at least a part or portion of the heat insulated casing such that any amount of moisture present in or on the at least a part or portion of the heat insulated casing is reduced.

The press apparatus in accordance with the second aspect of the present invention may be configured to, subsequently to the heating of the at least a part or portion of the heat insulated casing, carry out the treatment of the at least one article using the press apparatus.

In the context of the present application, treatment (of the at least one article) using the press apparatus may for example involve pressure treatment and/or temperature (heat) treatment. Pressure treatment may include heating, or heat treatment, after, before or in parallel with increase in pressure in the pressure vessel. In the context of the present application, the term “treatment” should be understood as encompassing one or more pressing phases, heating phases, hold phases, pumping phases, vacuum phases and/or cooling phases of a treatment cycle that may be carried out by the press apparatus.

The method and the system according to the first and second aspects of the present invention are generally directed to heating the heat insulated casing prior to carrying out the treatment using the press apparatus such that any moisture that may be present in or on the heat insulated casing is reduced. By heating at least a part or portion of the heat insulated casing such that any amount of moisture present in or on the at least a part or portion of the heat insulated casing is reduced—prior to carrying out the treatment of the at least one article using the press apparatus—the amount of any impurities in the pressure medium used in the press apparatus may be reduced or possibly even eliminated. For example, by heating at least a part or portion of the heat insulated casing, water and/or another or other liquids may be released, evaporated and/or diffused from one or more surfaces of the heat insulated casing. By means of heating at least a part or portion of the heat insulated casing, the at least a part or portion of the heat insulated casing may be dried. In the context of the present application, moisture should be understood as water or other liquid diffused in a small quantity as vapor, within a solid, within a porous medium such as the heat insulation material that may be included in the mantle, or condensed on a surface.

For example, by heating at least a part or portion of the heat insulated casing, any moisture present in or on the at least a part or portion of the heat insulated casing may be released from one or more surfaces of the at least a part or portion of the heat insulated casing. Molecules of water and/or another or substances may be bound to the one or more surfaces of the at least a part or portion of the heat insulated casing by means of physisorption. By heating at least a part or portion of the heat insulated casing, the molecules of water and/or another or substances bound to the one or more surfaces of the at least a part or portion of the heat insulated casing may be released from the one or more surfaces, as the forces binding the molecules of water and/or another or substances to the one or more surfaces of the at least a part or portion of the heat insulated casing by means of physisorption generally grow weaker as the temperature increases. The resulting water in gas phase (e.g., water vapor) and/or other gas may then be removed from the heat insulated casing. The water in gas phase and/or other gas resulting from the release of any moisture present in or on the at least a part or portion of the heat insulated casing may for example be removed from the heat insulated casing by means of (e.g., actively) withdrawing it/them from the heat insulated casing and/or from the pressure vessel (e.g., by sucking or evacuating it/them out of the heat insulated casing or the pressure vessel). The withdrawing of the water in gas phase and/or other gas resulting from the release of any moisture present in or on the at least a part or portion of the heat insulated casing from the heat insulated casing or the pressure vessel may for example be carried out by performing one or more vacuum phases of a treatment cycle, or one or more vacuum purges, of, e.g., the pressure vessel. For example, two or more vacuum phases or vacuum purges, such as three or four or six or more, may be carried out.

Thus, by heating the at least a part or portion of the heat insulated casing, any moisture present in or on the at least a part or portion of the heat insulated casing may be released from one or more surfaces of the at least a part or portion of the heat insulated casing. Subsequently to the heating of the at least a part or portion of the heat insulated casing and prior to the carrying out the treatment of the at least one article using the press apparatus, the gas resulting from the release of any moisture present in or on the at least a part or portion of the heat insulated casing may be withdrawn from the heat insulated casing or from the pressure vessel. The gas resulting from the release of any moisture present in or on the at least a part or portion of the heat insulated casing may be constituted by water in gas phase or by another gas, or by a mixture of water in gas phase and another or other gases.

By means of heating at least a part or portion of the heat insulated casing using at least one heating means prior to carrying out the treatment of the at least one article using the press apparatus, such that any amount of moisture present in or on the at least a part or portion of the heat insulated casing is reduced, there may be no or only very little build-up of water vapor in the pressure medium used in the press apparatus during the treatment. Thereby, the problem of undesired surface layers (discolorations) being formed on the treated articles may be mitigated or avoided altogether. Also, any adverse chemical reactions that could take place within the pressure vessel during treatment due to the presence of too much water vapor in the pressure medium used in the press apparatus during the treatment may be reduced or eliminated. Any such adverse chemical reactions could possibly damage components in or of the pressure vessel, e.g., components in or of the furnace chamber such as temperature sensors (e.g., thermocouple(s)) and/or associated wiring. Thus, by means of heating at least a part or portion of the heat insulated casing using at least one heating means, prior to carrying out the treatment of the at least one article using the press apparatus, such that any amount of moisture present in or on the at least a part or portion of the heat insulated casing is reduced, the lifetime of components in or of the pressure vessel might be relatively long. This may be particularly beneficial for a heat insulated casing made at least in part of carbon-based material such as graphite.

As described in the foregoing, by heating at least a part or portion of the heat insulated casing such that any amount of moisture present in or on the at least a part or portion of the heat insulated casing is reduced—prior to carrying out the treatment of the at least one article using the press apparatus—the amount of any impurities/water vapor in the pressure medium used in the press apparatus during the treatment may be reduced or eliminated. This may facilitate or allow for re-using a relatively large fraction of the pressure medium that was used in the press apparatus during the treatment in one or more subsequent treatments. For example, a relatively large fraction of the pressure medium that was used in the press apparatus during a treatment cycle may be re-used in one or more subsequent treatment cycles. After a treatment cycle has been completed, the pressure medium may be withdrawn from the pressure vessel, after which the pressure vessel may be opened for removal of the treated article(s). The pressure medium that is withdrawn from the pressure vessel may be guided into a pressure medium storage in fluid communication with the pressure vessel. Since, as described in the foregoing, the amount of any impurities/water vapor in the pressure medium used in the press apparatus during a treatment cycle may be relatively small or insignificant (i.e. the purity of the pressure medium may be relatively high), the pressure medium that is withdrawn from the pressure vessel and guided into a pressure medium storage may readily be used in the pressure vessel in a subsequent treatment cycle. To even further increase the purity of the pressure medium to be re-used, an appropriate filter may be arranged intermediate the pressure vessel and the pressure medium storage such that pressure medium that is withdrawn from the pressure vessel passes through the filter en route to the pressure medium storage. Such re-use of pressure medium may help in reducing the overall pressure medium consumption. Such re-use of pressure medium may be particularly beneficial for a heat insulated casing made at least in part of carbon-based material such as graphite. Pressure medium re-used from a treatment cycle may possibly be re-used in another type of pressure vessel or press apparatus. For example, after a treatment cycle has been completed in a press apparatus with a pressure vessel having a heat insulated casing made at least in part of carbon-based material such as graphite, the pressure medium may be withdrawn from the pressure vessel and subsequently be re-used in in a press apparatus with a pressure vessel having a heat insulated casing made at least in part of another type of material, such as, for example, molybdenum.

The preheating—i.e. the heating of at least a part or portion of the heat insulated casing carried out prior to carrying out the treatment of the at least one article using the press apparatus—may possibly be preceded by performing one or more vacuum phases of a treatment cycle, of, e.g., the pressure vessel.

In the context of the present application, by a vacuum phase of a treatment cycle it is meant a phase of the treatment cycle (e.g., an initial phase of the treatment cycle) including, after possibly having inserted the articles(s) to be treated in the pressure vessel, evacuating air and/or any other gas from the interior of the pressure vessel by means of one or more vacuum pumps.

The heat insulated casing referred to in the foregoing with reference to the method and the system according to the first and second aspects of the present invention may in alternative be referred to as a mantle.

As mentioned in the foregoing, in the context of the present application, the term “treatment” should be understood as encompassing one or more pressing phases, heating phases, hold phases, pumping phases, vacuum phases and/or cooling phases of a treatment cycle that may be carried out by the press apparatus. Some of the phases of a treatment cycle may be carried out concurrently or in overlapping time periods.

The heating of the at least a part or portion of the heat insulated casing using at least one heating means such that any amount of moisture present in or on the at least a part or portion of the heat insulated casing is reduced, may for example be carried out such that any amount of moisture present in or on the at least a part or portion of the heat insulated casing is not exceeding a certain (e.g., a selected, or predefined) threshold level of amount of moisture in the at least a part or portion of the heat insulated casing.

Further, the heating of the at least a part or portion of the heat insulated casing using at least one heating means such that any amount of moisture present in or on the at least a part or portion of the heat insulated casing is reduced, may for example be carried out so as to ensure that the concentration of any water vapor in the pressure medium used in the press apparatus during the treatment does not exceed a certain (e.g., a selected, or predefined) threshold concentration level. To do so, one may have to take into account that water vapor may be present in the pressure medium at the time of supplying the pressure medium to the pressure apparatus (e.g., from a pressure medium source), and that water vapor may originate from moisture that may be present in or on the article(s) to be treated, for example. The concentration of water vapor in the pressure medium at the time of supplying the pressure medium to the pressure apparatus (e.g., when the pressure medium is in a pressure medium source, which may be separate from the pressure vessel) might in some situations be (about) 2 ppm.

In order to ascertain that any amount of moisture present in or on the at least a part or portion of the heat insulated casing has been reduced (e.g., so as to not exceed a certain threshold level of amount of moisture in the at least a part or portion of the heat insulated casing), and/or that the concentration of any water vapor in the pressure medium used in the press apparatus during the treatment does not exceed a certain (e.g., a selected, or predefined) threshold concentration level, a moisture sensor and/or an oxygen sensor may be used. In addition to using a moisture sensor and/or an oxygen sensor, a gas chromatograph could be used, for example.

The moisture sensor and/or oxygen sensor (and/or a sensor of any other appropriate type) may be configured to sense amount of moisture directly or indirectly in pressure medium used in the pressure vessel during treatment. The moisture sensor and/or oxygen sensor (and/or a sensor of any other appropriate type) may be configured to sense amount of moisture indirectly by sensing some quantity/quantities from which the amount of moisture is derived or derivable. The moisture sensor and/or oxygen sensor (and/or a sensor of any other appropriate type) may for example be configured to sense amount of moisture directly or indirectly in the pressure medium within the heat insulated casing (e.g., in the furnace chamber, in a load compartment included in the furnace chamber, or in an interior of the heat insulating portion of the heat insulated casing) during treatment. To that end, the moisture sensor and/or oxygen sensor (and/or a sensor of any other appropriate type) may be arranged within the heat insulated casing (e.g., in the furnace chamber, in a load compartment included in the furnace chamber, or in an interior of the heat insulating portion of the heat insulated casing). However, the moisture sensor and/or oxygen sensor (and/or a sensor of any other appropriate type) could be arranged in another or other. For example, there could be provided a pressure medium diverting device, which may be configured to divert a portion of the pressure medium from, e.g., a space within the heat insulated casing (e.g., in the furnace chamber), to a pressure medium analyzing device which may be outside the pressure vessel. The pressure medium analyzing device may for example comprise the moisture sensor and/or oxygen sensor and/or a device for analyzing the composition (e.g., the chemical composition) of the pressure medium diverted by the pressure medium diverting device. The pressure medium analyzing device may in addition exhibit one or more other capabilities, such as, for example an ability to sense radiation. An ability to sense radiation may be useful for example if the article(s) that is/are treated include a container (e.g., a capsule, or can) holding radioactive material, in which case a possible leak in the container could be sensed by the pressure medium analyzing device. The pressure medium diverting device may comprise one or more pressure medium guiding passages or conduits. It is to be understood that analysis of pressure medium diverted from a part or portion of the pressure vessel, e.g., from a space within the heat insulated casing, may be carried out not only in conjunction with the preheating—i.e. the heating of at least a part or portion of the heat insulated casing carried out prior to carrying out the treatment of the at least one article using the press apparatus—as described herein, Rather, such analysis may be carried out independently of such preheating. For example, such analysis could be carried out during one or more selected phases of a treatment cycle, e.g., during a pressing phase of a treatment cycle. Analysis of the composition (e.g., the chemical composition) of pressure medium diverted from a part or portion of the pressure vessel, e.g., from a space within the heat insulated casing, may for example be carried out repeatedly (e.g., continuously) in order to monitor the composition of the pressure medium over a selected period of time. This may facilitate or allow for ensuring that the pressure medium in the part or portion of the pressure vessel has a certain (e.g., a desired or required) composition, possibly over the selected period of time. As one possible application, analysis of the composition of pressure medium diverted from a part or portion of the pressure vessel (e.g., from a space within the heat insulated casing) may be carried out to determine or monitor any level of carbon in the pressure medium in connection with (e.g., during) a case hardening process (including a carburizing process) such as disclosed in WO 2016/150490 A1.

In alternative or in addition, the moisture sensor and/or oxygen sensor (and/or a sensor of any other appropriate type) may be configured to sense amount of moisture directly or indirectly in the pressure medium in another part of the pressure vessel during treatment, for example in a space in the vicinity of or at the end closure.

A sensor may be provided, for example in the press apparatus. The sensor may be configured to sense amount of moisture in pressure medium within the heat insulated casing during treatment, in order to ensure that the concentration of any water vapor in the pressure medium within the heat insulated casing during the treatment does not exceed a certain threshold concentration level. The sensor may comprise or be constitute by the moisture sensor and/or oxygen sensor (and/or a sensor of any other appropriate type) as described in the foregoing.

The pressure medium used in the press apparatus (e.g., in the pressure vessel thereof) may for example comprise a gas, for example an inert gas such as Argon gas.

The heat insulated casing may be made from one or more of a variety of materials.

For example, the heat insulated casing, or at least the heat insulating portion and the housing thereof, may be metallic (e.g., made of materials consisting of one or more metals and/or metal alloys). Possibly, the heat insulated casing, or at least the heat insulating portion and the housing thereof, may be made entirely, or substantially entirely, of materials consisting of one or more metals and/or metal alloys. For a metallic heat insulated casing there may be relatively little accumulation of moisture in or on the heat insulated casing if it is temporarily arranged outside the pressure vessel for an extended period of time (e.g., for several hours, or overnight), as compared to heat insulated casings of other materials.

The heat insulated casing may for example comprise one or more ceramic fiber materials, such as, for example, Saffil manufactured by Unifrax (https://www.unifrax.com), MAFTEC polycrystalline alumina fiber materials, superwool, and/or one or more other types of ceramic materials, or any combination thereof. For example, an interior of the heat insulating portion of the heat insulated casing, or the material(s) constituting the heat insulating portion, may comprise or be constituted by one or more ceramic fiber materials.

It is to be understood that the heat insulated casing may comprise another or other types of materials than those mentioned in the foregoing. For example, the heat insulated casing could, in alternative or in addition, comprise a steel-based material or element, a molybdenum-based material or element, and/or a carbon-based material or element, such as, for example, a graphite and carbon fiber blanket or the like. According to other examples, the heat insulated casing could, in alternative or in addition, comprise titanium or a titanium-based material, and/or tungsten or a tungsten-based material.

The heating of the at least a part or portion of the heat insulated casing using at least one heating means may be carried out in different ways. For example, heating elements, such as, for example, electrical heating elements, may be employed.

At least one heating element, which may be operable to generate heat at a selected output power, may be used to heat at least a part or portion of the heat insulated casing at a selected output power of the at least one heating element and during a selected period of time. Thus, the heating of the at least a part or portion of the heat insulated casing using at least one heating means may comprise using at least one heating element, which may be operable to generate heat at a selected output power, to heat at least a part or portion of the heat insulated casing at a selected output power of the at least one heating element and during a selected period of time. The output power of the at least one heating element and the period of time may be selected such that any amount of moisture present in or on the at least a part or portion of the heat insulated casing is reduced (e.g., so as to not exceed a certain threshold level of amount of moisture in the at least a part or portion of the heat insulated casing).

Thus, the at least one heating means may for example comprise at least one heating element, such as, for example, at least one electrical heating element.

The desired or required output power of the at least one heating element may be achieved by controlling a current level of current provided to the at least one heating element.

The at least one heating element that may be comprised in or constitute the at least one heating means may for example be additional and/or separate heating element(s) dedicated for the preheating—i.e. the heating of at least a part or portion of the heat insulated casing carried out prior to carrying out the treatment of the at least one article using the press apparatus.

In alternative or in addition, the at least one heating element that may be comprised in or constitute the at least one heating means may be constituted by existing heating element(s) in the pressure vessel, which may be used for carrying out isostatic pressing such as HIP. As will be described in more detail in the following with reference to the appended drawings, the furnace chamber may comprise a furnace, or heater or heating elements, for heating of the pressure medium in the pressure vessel for example during a pressing phase of a treatment cycle. The at least one heating element that may be comprised in or constitute the at least one heating means may for example be constituted by the furnace, e.g., by any heater or heating elements of the furnace of the furnace chamber. In the context of the present application, the term “furnace” refers to the elements or means for providing heating, while the term “furnace chamber” refers to the area or region in which the furnace and possibly a load compartment and any article may be located.

The at least one heating element may be used to heat at least a portion of the heat insulating portion and/or at least a portion of the housing at the selected output power of the at least one heating element and during the selected period of time, such that any amount of moisture present in or on the at least a portion of the heat insulating portion and/or the at least a portion of the housing is reduced.

The at least one heating element may for example be arranged within or inside the heat insulated casing. For example, the at least one heating element may be arranged in an interior of the heat insulating portion of the heat insulated casing. In addition or in alternative, the at least one heating element could be arranged at (e.g., coupled to) an inner surface of the heat insulating portion of the heat insulated casing. Each or any heating element may for example comprise one or more metallic resistance heating elements, e.g., in the form of one or more wires, strips and/or ribbons, which may be arranged in (e.g., embedded in) the material(s) constituting the heat insulating portion. The one or more resistance heating elements could be made of one or more alloys. An advantage of a configuration wherein the at least one heating element is arranged within the heat insulated casing is that an outer surface of the heat insulated casing may be kept relatively cool, even during or after operating the at least one heating element. This may facilitate any manual handling of the heat insulated casing, which may be needed for example if the heating of the at least a part or portion of the heat insulated casing is carried out while the heat insulated casing is removed from the pressure vessel and the heat insulated casing have to be (re-)arranged, or loaded, in the pressure vessel in order to carry out the treatment using the press apparatus, as will be further described in the following.

One or more temperature sensors (e.g., one or more thermocouples) may be provided at each or any heating element to ensure that the material(s) constituting the heat insulating portion or the heating element(s) do or does not become subjected to a temperature exceeding any maximally allowed temperature the material(s) constituting the heat insulating portion or heating element(s) is or are allowed to be subjected to by the operation of the heating element(s).

As mentioned in the foregoing, the desired or required output power of the at least one heating element may be achieved by controlling a current level of current provided to the at least one heating element. The current level of current provided to the at least one heating element may be limited or adjusted based on pressure level in the pressure vessel. This is due to that (particularly) at very low pressures in the pressure vessel, the temperature of the at least one heating element may become so high that properties of material(s) comprised in or constituting the heat insulating portion which the at least one heating element may be embedded in (e.g., electrical conductivity) may change in an undesired way. For example, any electrical insulators for any heating strips, wires or the like of the at least one heating element could change in an undesired way if heated too much. By limiting or adjusting the current level of current provided to the at least one heating element based on pressure level in the pressure vessel, any such undesired changes in properties of material(s) comprised in or constituting the heat insulating portion may be reduced or even avoided. This also applies to, e.g., the furnace in the furnace chamber (e.g., to any heating element(s) of the furnace). For example, material properties of the isolators for any heating strips or wires of the furnace or heating element(s) of the furnace could change in an undesired way if heated too much. Accordingly, in alternative or addition, the current level of current provided to the furnace or heating element(s) of the furnace may be limited or adjusted based on pressure level in the pressure vessel. A limit for the current level of current provided to the furnace or heating element(s) of the furnace may be based on a temperature on the furnace or heating element(s) of the furnace, which temperature may be determined based on an electrical resistance of the furnace or heating element(s) of the furnace. The furnace in the furnace chamber is described further in the following with reference to the figures.

The press apparatus may comprise a pressure medium flow generator, which may be configured to generate a flow of pressure medium in the furnace chamber and the at least one pressure medium guiding passage. The pressure medium flow generator may for example comprise or be constituted by one or more fans and/or ejectors. Concurrently with and/or after using at least one heating element to heat the at least a part or portion of the heat insulated casing, the pressure medium flow generator may be operated to generate a flow of pressure medium in the furnace chamber and the at least one pressure medium guiding passage. By operating the pressure medium flow generator to generate a flow of pressure medium in the furnace chamber and the at least one pressure medium guiding passage concurrently with or after using at least one heating element to heat the at least a part or portion of the heat insulated casing, the at least one article, which is to be subjected to treatment, and possibly also other components in the pressure vessel, may also be heated and dried. For example, the heat insulated casing and a bottom insulating portion (which is described further in the following with reference to the figures), which bottom insulating portion may or may not be considered as a part of the heat insulated casing, may be heated and dried. Also, it may facilitate or allow for heating of a relatively large part or portion of the heat insulated casing without requiring a large number of heating elements, because heat generated by the least one heating element may be transported by way of heated pressure medium through the heat insulated casing as the heated pressure medium flows through the at least one pressure medium guiding passage of the heat insulated casing. There may be a flow of heated pressure medium into the heat insulated casing (e.g., into the material(s) constituting the heat insulating portion, or into space(s) or void(s) within the heat insulating portion), for example via one or more holes or openings that may be formed within the at least one pressure medium guiding passage of the heat insulated casing. According to one example, at least a part or portion of the heat insulated casing, such as the heat insulating portion, may comprise a layered structure having an outer layer, an intermediate layer (or several) and an inner layer, with the intermediate layer arranged between the outer layer and the inner layer, and with heat insulation material arranged between the intermediate layer and the inner layer. The heat insulation material may for example be sandwiched between the intermediate layer and the inner layer. Each or any of the outer layer, the intermediate layer and the inner layer may for example be made of steel or steel-based material, molybdenum or a molybdenum-based material, and/or carbon or a carbon-based material, such as, for example, graphite. According to one example, the outer layer and the intermediate layer may be made of steel, and the inner layer may be made of molybdenum. The heat insulation material may for example be constituted or comprise one or more ceramic fiber materials, such as, for example, Saffil, MAFTEC polycrystalline alumina fiber materials, superwool, and/or one or more other types of ceramic materials, or any combination thereof. Between the outer layer and the intermediate layer and/or between the intermediate layer and the inner layer there may be provided spacers, e.g., comprising so called angle irons, for spacing the layers from each other. The at least one pressure medium guiding passage of the heat insulated casing may be between the outer layer and the intermediate layer. The intermediate layer may be provided with one or more holes or openings. Accordingly, if the pressure medium flow generator is operated to generate a flow of pressure medium in the furnace chamber and the at least one pressure medium guiding passage of the heat insulated casing, there may be a flow of heated pressure medium into the heat insulation material.

Different positions of the at least one heating element are possible. For example, the at least one heating element may be arranged in a part of the at least one pressure medium guiding passage. In alternative or in addition, the at least one heating element may be arranged in a part of the furnace chamber.

The heat insulated casing may be removably arranged in the pressure vessel such that the heat insulated casing can be at least temporarily removed from the pressure vessel. For example, the heat insulated casing may be removed from the pressure vessel in order to place or replace article(s) in the furnace chamber, prior to carrying out treatment of the article(s) using the press apparatus, or to remove article(s) from the furnace chamber after completion of treatment of the article(s) using the press apparatus.

The heating of the at least a part or portion of the heat insulated casing may be carried out while the heat insulated casing is removed from the pressure vessel.

For example, the heat insulated casing may be removed from the pressure vessel, and the heating of the at least a part or portion of the heat insulated casing using the at least one heating element may be carried out while the heat insulated casing is removed from the pressure vessel. Subsequently to carrying out the heating of the at least a part or portion of the heat insulated casing using the at least one heating element, the heat insulated casing may be arranged in the pressure vessel.

Thus, the carrying out of the heating of the at least a part or portion of the heat insulated casing using the at least one heating element may comprise removing the heat insulated casing from the pressure vessel, carrying out the heating of the at least a part or portion of the heat insulated casing using the at least one heating element while the heat insulated casing is removed from the pressure vessel, and subsequently to carrying out the heating of the at least a part or portion of the heat insulated casing using the at least one heating element, arranging the heat insulated casing in the pressure vessel.

As mentioned in the foregoing, different positions of the at least one heating element are possible. Possibly, the at least one heating element may not be arranged in the heat insulated casing. For example, subsequently to removing the heat insulated casing from the pressure vessel, the heat insulated casing may be placed in a container, which may be arranged to accommodate the heat insulated casing. The at least one heating element may be arranged in or on the container, such that when the heat insulated casing is placed in the container, the at least one heating element can be used to heat the at least a part or portion of the heat insulated casing. The heating of the at least a part or portion of the heat insulated casing using the at least one heating element may be carried out while the heat insulated casing is placed in the container. Subsequently to carrying out the heating of the at least a part or portion of the heat insulated casing using the at least one heating element, the heat insulated casing may be removed from the container. Subsequently, the heat insulated casing may be arranged in the pressure vessel. The container may for example be comprised in or be constituted by a furnace chamber (that may be different from the furnace chamber of the pressure vessel, and separate from the pressure vessel), which may comprise a furnace that may comprise or constitute the at least one heating element. The container may comprise a support construction arranged to support the heat insulating casing after it has been taken out of the pressure vessel, for example in order to place, replace or remove article(s) in/from the furnace chamber. The container may in addition be arranged to support one or more further components, such as, for example, a furnace base, which may be removably arranged in the pressure vessel such that the one or more further components can be at least temporarily removed from the pressure vessel. The furnace base is described further in the following with reference to the figures. The furnace base may in alternative be referred to as a bottom insulating portion. The bottom insulating portion, or furnace base, may or may not be considered as a part of the heat insulating casing. The bottom insulating portion may or may not be removed from the pressure vessel together with the heat insulated casing. In case the bottom insulating portion is removed from the pressure vessel together with the heat insulated casing, the bottom insulating portion may be supported in or by the container together with the heat insulating casing after they have been taken out of the pressure vessel.

As will be described in the following with reference to the figures, the furnace chamber may comprise a load basket that may be configured to hold article(s) to be treated. The load basket may be arranged on the bottom insulating portion.

Possibly, the bottom insulating portion may be removed from the pressure vessel while the heat insulating casing is not removed from the pressure vessel. For placing, replacing or removing article(s) from the furnace chamber, it may, if the load basket is arranged on the bottom insulating portion, be sufficient to remove bottom insulating portion (and hence also the load basket) from the pressure vessel, with the heat insulating casing remaining in the pressure vessel. Once the bottom insulating portion and the load basket have been removed from the pressure vessel, article(s) may be placed, replaced or removed from the load basket. Subsequently, the bottom insulating portion and the load basket may be reinserted in the pressure vessel.

An advantage of using a container such as described in the foregoing, with at least one heating element being arranged in or on the container such that when the heat insulated casing is placed in the container the at least one heating element can be used to heat the at least a part or portion of the heat insulated casing, is that the construction of the heat insulated casing may be less complex, as compared to, e.g., using a configuration with the at least one heating element that may be comprised in the at least one heating means being arranged within the heat insulated casing. If using a container such as described in the foregoing, there may be reduced or even no need for heating element(s) within the heat insulated casing for the preheating (i.e. the heating of at least a part or portion of the heat insulated casing carried out prior to carrying out the treatment of the at least one article using the press apparatus).

The heat insulating casing and possibly also the bottom insulating portion or furnace base might be supported in the container for an extended period of time (e.g., for several hours, or overnight). To reduce the amount of accumulation of moisture in or on the heat insulated casing during the extended period of time, the container may be made of material(s) which have relatively little tendency for oxidation in ambient air. In alternative or in addition, to reduce the amount of accumulation of moisture in or on the heat insulated casing during the extended period of time, the container may be closed and the interior of the container may be pressurized with a gas, preferably an inert gas such as Argon gas. Thus, the container may possibly be arranged so that it can be closed (with the heat insulating casing therein) and such that its interior can be pressurized with a gas. The amount of gas used to pressurize the interior of the container should be sufficient to ensure that no or only insignificant transport of air or moisture can take place from the exterior of the container into its interior.

As mentioned in the foregoing, the press apparatus may comprise a pressure medium flow generator, which may be configured to generate a flow of pressure medium in the furnace chamber and the at least one pressure medium guiding passage. Heated pressure medium may be introduced into the pressure vessel. The pressure medium flow generator may be operated to generate a flow of the heated pressure medium in the furnace chamber and the at least one pressure medium guiding passage during a selected period of time. The heated pressure medium may include an amount of thermal energy such that by transfer of thermal energy from the heated pressure medium to the at least a part or portion of the heat insulated casing, during the passage of the heated pressure medium in the furnace chamber and the at least one pressure medium guiding passage and during the selected period of time, the at least a part or portion of the heat insulated casing is heated such that any amount of moisture present in or on the at least a part or portion of the heat insulated casing is reduced. The selected period of time may for example be within a range of 5 to 30 minutes, e.g., 10 to 30 minutes, or 15 to 20 minutes.

Thus, the heating of the at least a part or portion of the heat insulated casing using at least one heating means may comprise introducing heated pressure medium into the pressure vessel, and operating the pressure medium flow generator to generate a flow of the heated pressure medium in the furnace chamber and the at least one pressure medium guiding passage during a selected period of time.

The temperature of the heated pressure medium is preferably in a range from (about) 50° C. to (about) 400° C., more preferably in a range from (about) 100° C. to (about) 400° C., or from (about) 100° C. to (about) 300° C. However, the temperature of the heated pressure medium could be lower than 50° C. or higher than 400° C. For example, the temperature of the heated pressure medium in the vicinity of or in the at least one pressure medium guiding passage of the heat insulated casing (e.g., at an upper part of the heat insulated casing) may be in a range from (about) 50° C. to (about) 400° C., more preferably in a range from (about) 100° C. to (about) 400° C., or from (about) 100° C. to (about) 300° C.

The heated pressure medium may for example comprise re-used pressure medium. The heated pressure medium may for example have been used in the press apparatus during a previous occasion of treatment using the press apparatus. Thus, the at least one heating means may, in alternative or in addition, comprise heated pressure medium, such as, for example, re-used pressure medium, or pressure medium that has been used in the press apparatus during a previous occasion of treatment using the press apparatus. After a treatment using the press apparatus, all or at least some of the pressure medium in the pressure vessel may be removed from the pressure vessel in a manner known in the art, and may possibly be stored in a pressure medium container. As a result of having used the pressure medium in the press apparatus during a previous occasion of treatment (including, e.g., one or more pressing phase(s), heating phase(s) and possibly hold phase(s)), the pressure medium may have a relatively high temperature. In alternative or in addition, re-used pressure medium may be heated, e.g., using any way known in the art, before reintroducing it into the pressure vessel. Such re-use of pressure medium may help in reducing the overall pressure medium consumption.

A certain (e.g., a selected) portion of the amount of pressure medium that has been used in the press apparatus during a previous occasion of treatment using the press apparatus may be re-used as (heated) pressure medium that may be introduced into the pressure vessel for carrying out the heating of the at least a part or portion of the heat insulated casing. For example, an amount of the pressure medium, which has been used in the press apparatus during a previous occasion of treatment using the press apparatus, corresponding to a pressure in the pressure vessel of about 40 bar may be re-used in such a way.

The pressure vessel may for example be cylindrical, or substantially cylindrical. The outer surface of the outer walls of the pressure vessel may be provided with channels, conduits or tubes, etc., which channels, conduits or tubes for example may be arranged so as to be in connection with the outer surface of the outer wall of the pressure vessel and may be arranged to run parallel to an axial direction of the pressure vessel and/or helically or spirally around the outer surface of the outer wall of the pressure vessel. A coolant, or cooling medium, for cooling of the walls of the pressure vessel may be provided in the channels, conduits or tubes, whereby the walls of the pressure vessel may be cooled in order to protect the walls from detrimental heat building up during operation of the pressure vessel or the press apparatus. The coolant in the channels, conduits or tubes may for example comprise water, but another or other types of coolants are possible. On the outer surface of the outer walls of the pressure vessel, and possibly on any channels, conduits and/or tubes, etc. for coolant, pre-stressing means may be provided. The pre-stressing means may for example be provided in the form of wires (e.g., made of steel) wound in a plurality of turns so as to form one or more bands, and preferably in several layers, around the outer surface of the outer walls of the pressure vessel and possibly also any channels, conduits and/or tubes, etc. for coolant that may be provided thereon. The pre-stressing means may be arranged for exerting radial compressive forces on the pressure vessel. The pre-stressing means may accommodate radial and possibly axial forces exerted on the pressure vessel.

Such pre-stressing means may facilitate or allow for the outer wall(s) of the pressure vessel to have a relatively small thickness. Without such pre-stressing means, the outer wall(s) of the pressure vessel may need to have a larger thickness to withstand radial and possibly axial forces exerted on the pressure vessel. A pressure vessel without such pre-stressing means and having outer wall(s) with a relatively large thickness may be referred to as a monoblock pressure vessel. It is to be understood that such pre-stressing means are optional, and not required, and that the pressure vessel may or may not be provided with such pre-stressing means (for example, the pressure vessel may or may not be a monoblock pressure vessel).

As indicated in the foregoing, the outer surface of a wall of the pressure vessel may be provided with a cooling medium circuit. The cooling medium circuit may extend along at least a portion of the outer surface of the pressure vessel. The cooling medium circuit may be configured to circulate a cooling medium, or coolant, therein. The cooling medium may be heated, and the heated cooling medium may be circulated in the cooling medium circuit during a selected period of time. The heating of the cooling medium may be carried out such that the heated cooling medium includes an amount of thermal energy, such that by transfer of thermal energy from the heated cooling medium to the wall of the pressure vessel during the circulation of the heated cooling medium in the cooling medium circuit during the selected period of time—whereby thermal energy is transferred to the interior of the pressure vessel—the at least a part or portion of the heat insulated casing is heated such that any amount of moisture present in or on the at least a part or portion of the heat insulated casing is reduced. Thus, the heating of the at least a part or portion of the heat insulated casing using at least one heating means may for example comprise heating the cooling medium, and circulating the heated cooling medium in the cooling medium circuit during a selected period of time.

Thus, the at least one heating means may, in alternative or in addition, comprise heated cooling medium in any cooling medium circuit provided at the outer surface of the wall of the pressure vessel. The cooling medium may for example comprise water, although in alternative or in addition another or other types of cooling mediums may be employed.

The maximum temperature of the cooling medium that is allowed/feasible may depend on choice of material of the wires of any pre-stressing means as described in the foregoing. The higher the temperature of the heated cooling medium, the less time may be required to reduce any amount of moisture present in or on the at least a part or portion of the heat insulated casing so as to not exceed a certain (e.g., a selected, or predefined) threshold level of amount of moisture in the at least a part or portion of the heat insulated casing.

The pressure medium may comprise one or more gases. For example, as mentioned in the foregoing, the pressure medium may comprise an inert gas such as Argon gas. One or more getter materials or purifying agents may be arranged within the pressure vessel so as to be exposed to the pressure medium during the treatment of the at least one article using the press apparatus. The one or more getter materials purifying agents may be configured to trap or remove particles (e.g., molecules) of one or more selected gases from the pressure medium. The one or more selected gases may for example comprise water vapor.

If the preheating—i.e. the heating of at least a part or portion of the heat insulated casing carried out prior to carrying out the treatment of the at least one article using the press apparatus—would not be sufficient, e.g., so as to ensure that a certain threshold level of amount of moisture in the at least a part or portion of the heat insulated casing is not exceeded, use of getter materials within the pressure vessel may be useful for ensuring that the concentration of any water vapor in the pressure medium used in the press apparatus during the treatment does not exceed a certain (e.g., a selected, or predefined) threshold concentration level.

In the context of the present application, by a getter material it is meant in principle any material(s), in any shape(s) or form(s), that is/are capable of physically and/or chemically trapping and removing reactive gas molecules from a gas phase within the pressure vessel, and maintaining the reactive gas molecules adsorbed or chemically bonded to the getter material such that the reactive gas molecules cannot disassociate themselves from the getter material to re-join the gas phase (e.g., the pressure medium), at least not during the treatment of the at least one article using the press apparatus. In the context of the present application, the reactive gas molecules may be gas molecules that may form coatings on the articles treated during the treatment using the press apparatus. For example, oxygen-containing gases such as water vapor may form oxides on the articles.

The getter material(s) may for example comprise or be constituted by Ti (titan), e.g., a plurality of Ti elements or particles, such as Ti chips or a Ti foil. Ti-based getter materials may be especially useful for removing oxygen-containing gases from a gas phase within the pressure vessel. However, other getter material(s) may in alternative or in addition be used.

The getter material(s) within the pressure vessel may for example be provided by making one or more of the components in the pressure vessel at least in part of the getter material(s). For example, a part or portion of the furnace chamber or some element comprised in the furnace chamber could comprise the getter material(s). As will be described in the following with reference to the figures, the furnace chamber may comprise a load basket that may be configured to hold article(s) to be treated. The load basket could be wholly or partly made of one or more getter materials such as Ti.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

FIG. 1 is schematic graphs of the fraction of water vapor in the pressure medium at atmospheric pressure C as a function of pressure P at which the treatment is carried out, for different types of materials.

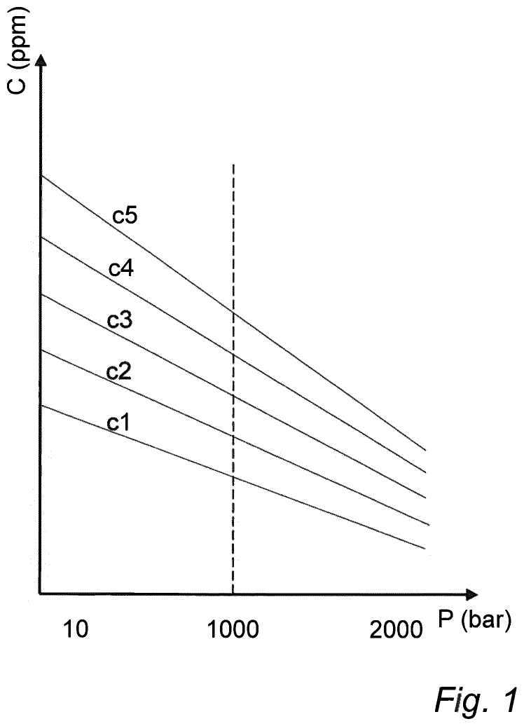

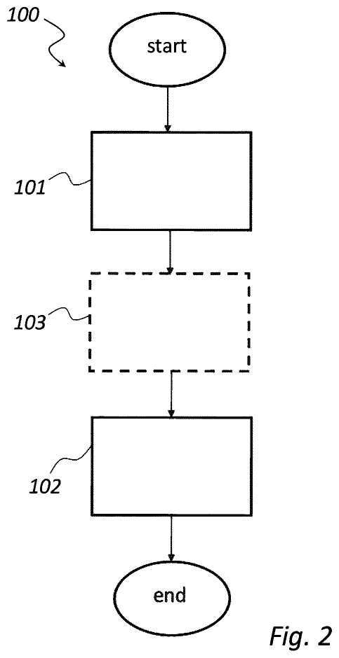

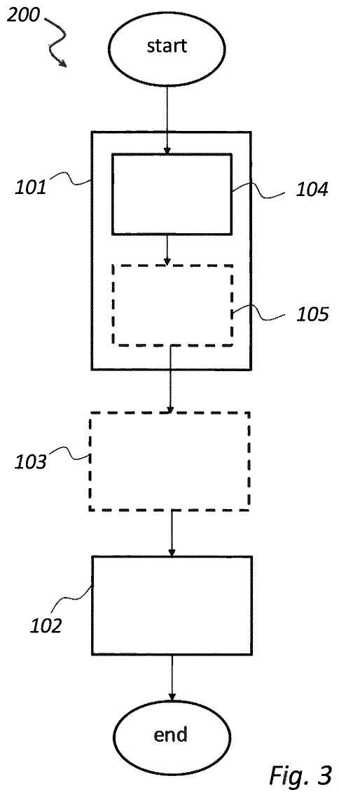

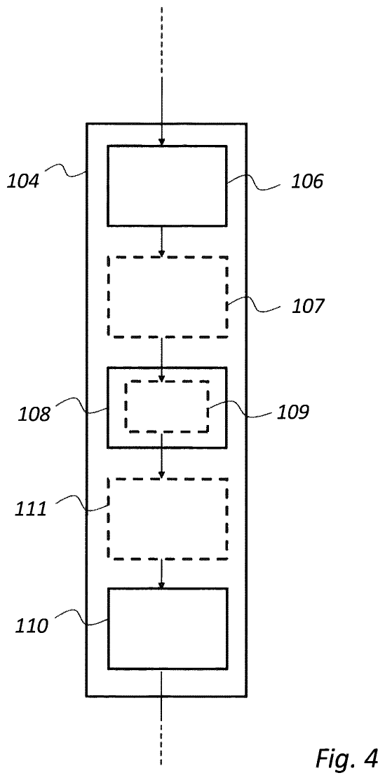

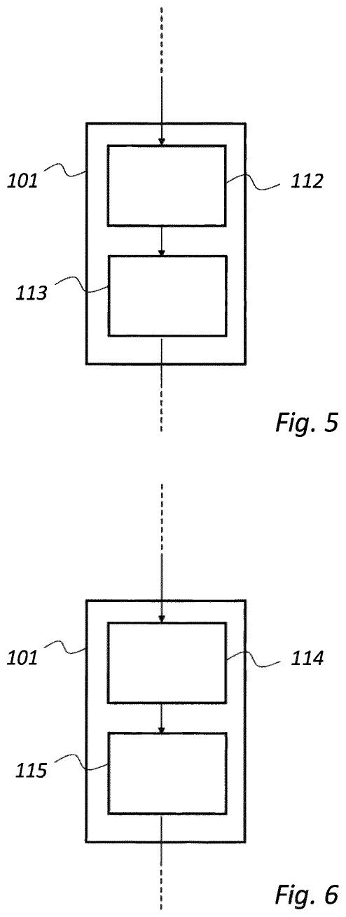

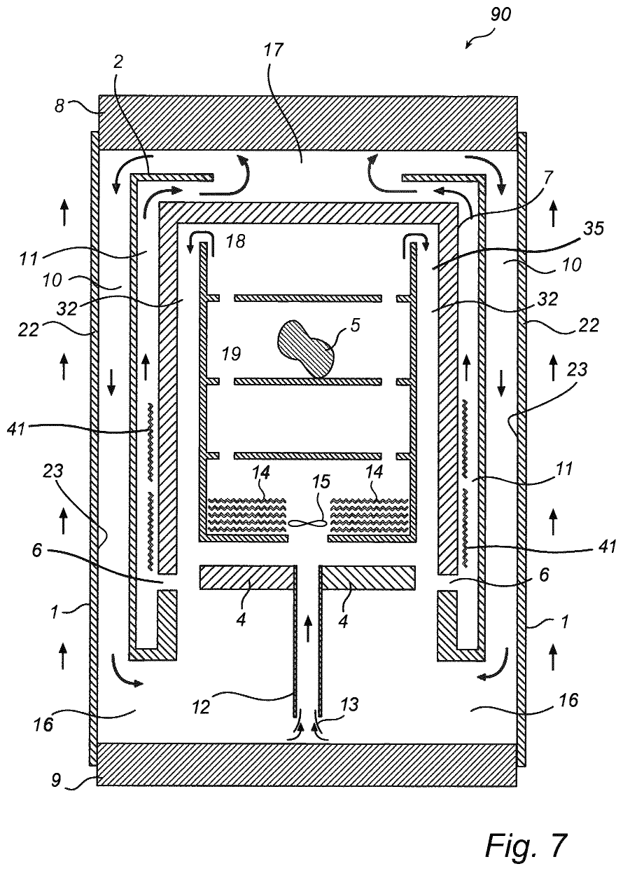

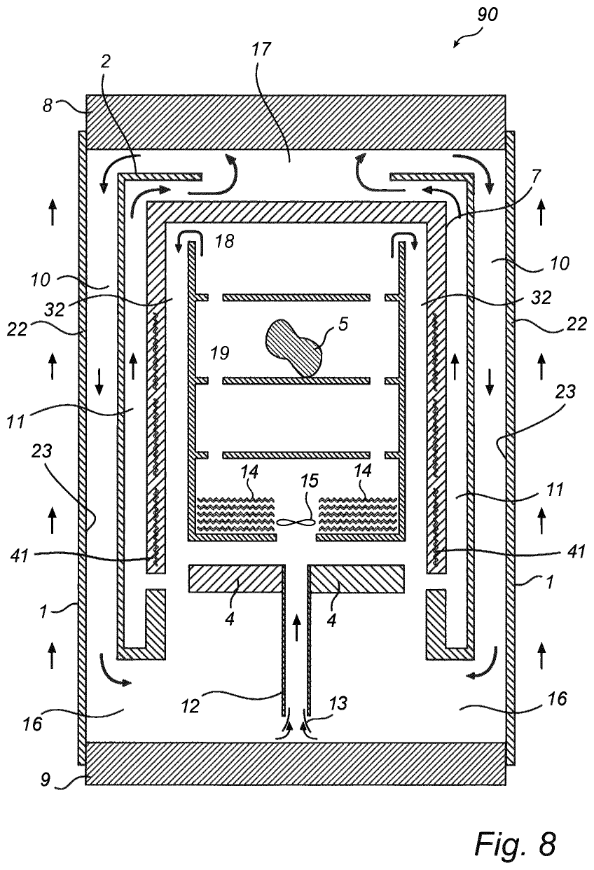

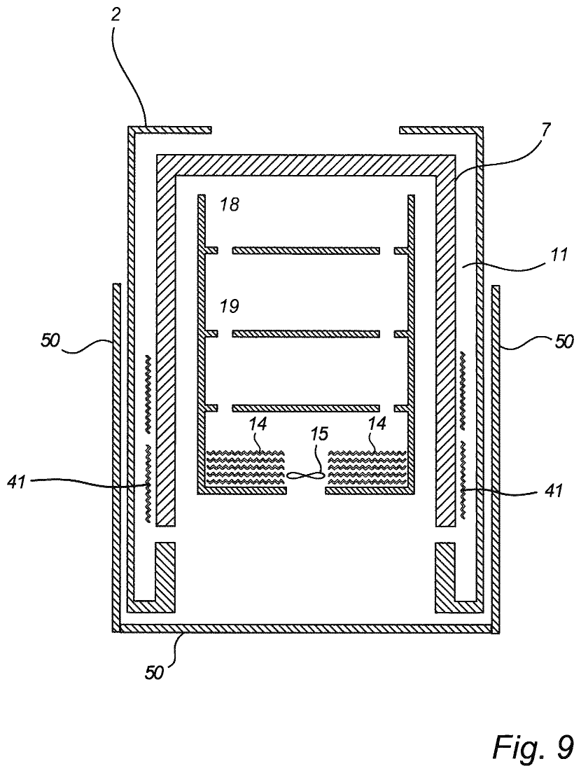

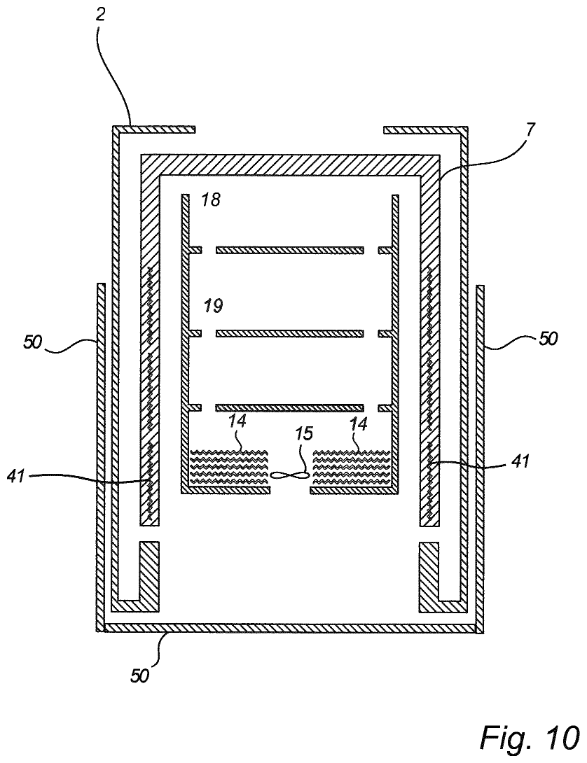

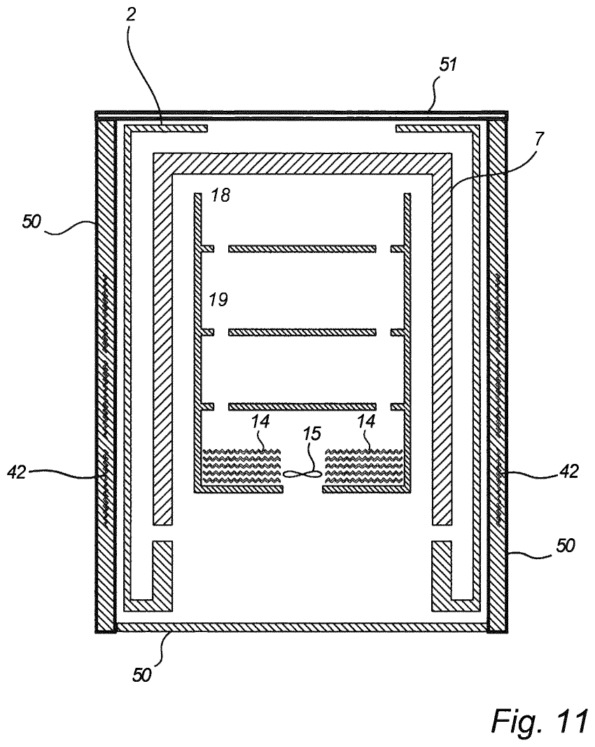

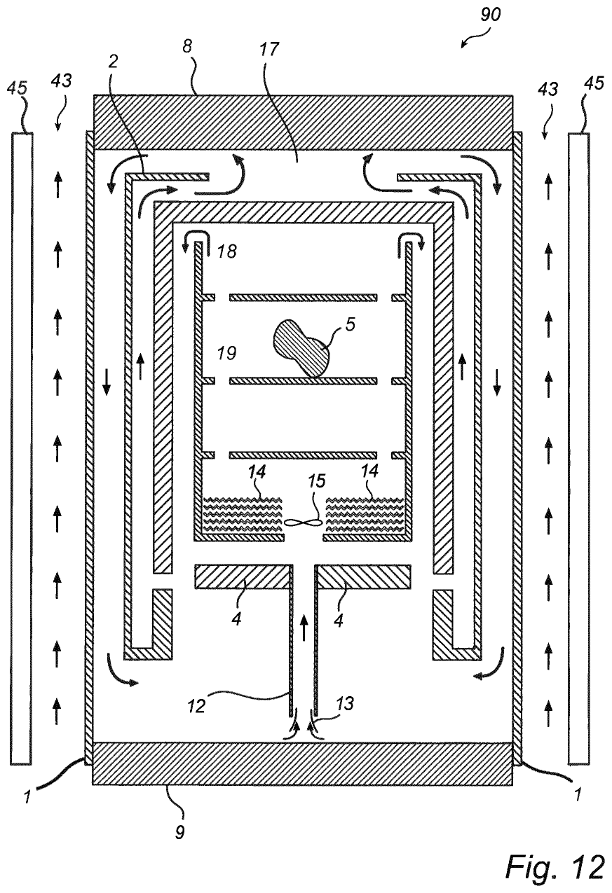

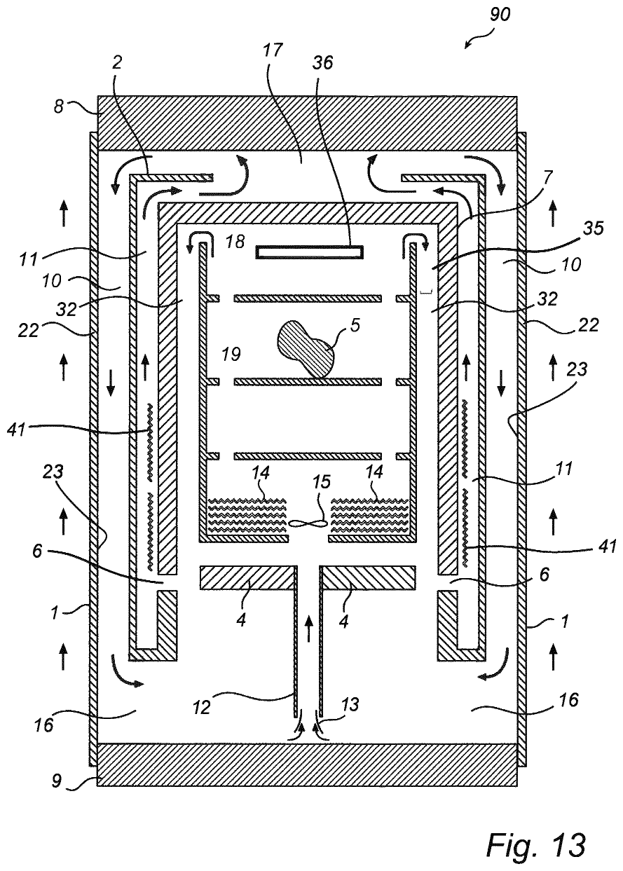

Each of FIGS. and 2 and 3 is a schematic flowchart illustrating a method according to an embodiment of the present invention.

Each of FIGS. 4 to 6 is a schematic flowchart illustrating a part of a method for a press apparatus, according to an embodiment of the present invention Each of FIGS. 7 and 8 is a schematic, in part sectional, side view of a system according to an embodiment of the present invention.

Each of FIGS. 9, 10 and 11 is a schematic, in part sectional, side view of parts of a system in accordance with an embodiment of the present invention.

Each of FIGS. 12 and 13 is a schematic, in part sectional, side view of a system according to an embodiment of the present invention.

The figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are illustrated. The present invention may, however, be embodied in many different forms and should not be construed as limited to the embodiments of the present invention set forth herein; rather, these embodiments are provided by way of example so that this disclosure will convey the scope of the present invention to those skilled in the art.

FIG. 2 is a schematic flowchart illustrating a method 100 for a press apparatus, according to an embodiment of the present invention. The press apparatus comprises a pressure vessel arranged to hold pressure medium therein during use of the press apparatus. The pressure vessel comprises an end closure. There may be a first end closure and a second end closure comprised in the pressure vessel. For example in case the pressure vessel is arranged upright (e.g., such that a length direction of the pressure vessel is along a vertical direction), the first end closure and the second end closure could be referred to as an upper, or top, end closure and a lower end closure. The press apparatus comprises a heat insulated casing, which is arranged within the pressure vessel. The heat insulated casing at least partly encloses a furnace chamber, which is arranged so that pressure medium can enter and exit the furnace chamber. The heat insulated casing comprises a heat insulating portion, which at least partly encloses the furnace chamber, and a housing, which at least partly encloses the heat insulating portion. A treatment region, arranged to accommodate at least one article, is at least in part defined by the furnace chamber. The press apparatus is configured to subject the at least one article to treatment. The heat insulated casing comprises at least one pressure medium guiding passage, which is formed between at least a portion of the housing and at least a portion of the heat insulating portion. The at least one pressure medium guiding passage is arranged to, during use of the press apparatus, guide pressure medium that has exited the furnace chamber towards the end closure such that pressure medium having exited the at least one pressure medium guiding passage can be guided in proximity to an inner surface of a wall of the pressure vessel.

The method 100 comprises, at 101, prior to carrying out the treatment of the at least one article using the press apparatus, heating at least a part or portion of the heat insulated casing using at least one heating means such that any amount of moisture present in or on the at least a part or portion of the heat insulated casing is reduced.

By heating the at least a part or portion of the heat insulated casing, moisture present in or on the at least a part or portion of the heat insulated casing may be released from one or more surfaces of the at least a part or portion of the heat insulated casing. Possibly, the method 100 may comprise, at 103, subsequently to the heating of the at least a part or portion of the heat insulated casing, withdrawing the gas resulting from the release of moisture present in or on the at least a part or portion of the heat insulated casing from the heat insulated casing or from the pressure vessel. Heating of the at least a part or portion of the heat insulated casing may or may not continue to be carried out during withdrawal of the gas resulting from the release of moisture present in or on the at least a part or portion of the heat insulated casing from the heat insulated casing or from the pressure vessel. The withdrawing of the gas resulting from the release of moisture present in or on the at least a part or portion of the heat insulated casing from the heat insulated casing or the pressure vessel may for example carried out by performing one or more vacuum phases of a treatment cycle using the press apparatus.

At 102, subsequently to the heating of the at least a part or portion of the heat insulated casing, the treatment of the at least one article using the press apparatus is carried out. The treatment may for example comprise or be constituted by a so-called high-pressure heat treatment phase, in which the at least one article may be subjected to relatively high pressure and relatively high temperature.

The step 103 is in principle optional, and may be omitted, which is indicated by the dashed lines forming the element indicated by 103 in FIG. 2. Thus, in the method 100 the step 101 may be immediately followed by the step 102, with step 103 omitted.

The heating of the at least a part or portion of the heat insulated casing using at least one heating means, as in step 101 in FIG. 2, may be implemented or realized in several ways, e.g., as illustrated in FIG. 3.

FIG. 3 is a schematic flowchart illustrating a method 200 for a press apparatus, according to an embodiment of the present invention. The method 200 comprises steps 101, 102 and 103, wherein the steps 102 and 103 are the same or similar to the steps 102 and 103, respectively, illustrated in FIG. 2. Just as step 103 illustrated in FIG. 2, step 103 illustrated in FIG. 3 is optional, and may be omitted.

At 101, illustrated in FIG. 3, prior to carrying out the treatment of the at least one article using the press apparatus, at least a part or portion of the heat insulated casing is heated using at least one heating means such that any amount of moisture present in or on the at least a part or portion of the heat insulated casing is reduced. In accordance with the embodiment of the present invention illustrated in FIG. 3, the step 101 comprises, at 104, using at least one heating element, operable to generate heat at a selected output power, to heat at least a part or portion of the heat insulated casing at a selected output power of the at least one heating element and during a selected period of time. The output power of the at least one heating element and the period of time are selected such that any amount of moisture present in or on the at least a part or portion of the heat insulated casing is reduced.

The at least one heating element may for example be arranged within the heat insulated casing. The press apparatus may comprise a pressure medium flow generator, which may be configured to generate a flow of pressure medium in the furnace chamber and the at least one pressure medium guiding passage. The pressure medium flow generator may for example comprise or be constituted by one or more fans and/or ejectors. For example, in case the at least one heating element is arranged within the heat insulated casing, it may be particularly beneficial to carry out the additional step 105, which is comprised in step 101 in FIG. 3. At 105, concurrently with and/or after using at least one heating element to heat the at least a part or portion of the heat insulated casing, the pressure medium flow generator is operated to generate a flow of pressure medium in the furnace chamber and the at least one pressure medium guiding passage. By operating the pressure medium flow generator to generate a flow of pressure medium in the furnace chamber and the at least one pressure medium guiding passage concurrently with or after using at least one heating element to heat the at least a part or portion of the heat insulated casing, the at least one article, which is to be subjected to treatment, may also be heated and dried. In addition to the at least one article, other components in the pressure vessel may also be heated and dried. Also, the action at 105 may facilitate or allow heating of a relatively large part or portion of the heat insulated casing without requiring a large number of heating elements, because heated generated by the least one heating element may be transported via heated pressure medium through the heat insulated casing as the heated pressure medium flows through the at least one pressure medium guiding passage of the heat insulated casing. It is however to be understood that the step 105 is optional, and may be omitted, which is indicated by the dashed lines forming the element indicated by 105 in FIG. 3. Thus, in the method 200, the step 101 may comprise only step 104, with step 105 omitted. In that case, the step 104 is immediately followed by step 103, or by step 102 (since step 103 is optional and may be omitted).

As described in the foregoing, the at least one heating element may for example be arranged within the heat insulated casing. However, different positions of the at least one heating element are possible. The at least one heating element may not necessarily be arranged within the heat insulated casing, or possibly even not in the pressure vessel. For example, the heat insulated casing could be removably arranged in the pressure vessel, such that the heat insulated casing can be at least temporarily removed from the pressure vessel. For example, the heat insulated casing may be removed from the pressure vessel in order to place or replace article(s) in the furnace chamber, prior to carrying out treatment of the article(s) using the press apparatus, or to remove article(s) from the furnace chamber, after completion of treatment of the article(s) using the press apparatus. The heating of the at least a part or portion of the heat insulated casing could be carried out while the heat insulated casing is removed from the pressure vessel.

The case where the heat insulated casing is removably arranged in the pressure vessel, such that the heat insulated casing can be at least temporarily removed from the pressure vessel, and the heating of the at least a part or portion of the heat insulated casing is carried out while the heat insulated casing is removed from the pressure vessel, is illustrated in FIG. 4.

FIG. 4 is a schematic flowchart illustrating a part of a method for a press apparatus, according to an embodiment of the present invention. FIG. 4 illustrates exemplifying ways of how the carrying out of the heating of the at least a part or portion of the heat insulated casing using the at least one heating element may be implemented or realized. Thus, FIG. 4 illustrates exemplifying ways of how step 104 in FIG. 3 may be implemented or realized. Accordingly, the illustrated part of the method illustrated in FIG. 4 comprises step 104, at which step the at least one heating element, operable to generate heat at a selected output power, is used to heat at least a part or portion of the heat insulated casing at a selected output power of the at least one heating element and during a selected period of time.

According to the embodiment of the present invention illustrated in FIG. 4, the step 104 comprises, at 106, removing the heat insulated casing from the pressure vessel.

Possibly, at 107, subsequently to removing the heat insulated casing from the pressure vessel, the heat insulated casing may be placed in a container arranged to accommodate the heat insulated casing. The at least one heating element may be arranged in or on the container such that when the heat insulated casing is placed in the container, the at least one heating element can be used to heat the at least a part or portion of the heat insulated casing.

At 108, the heating of the at least a part or portion of the heat insulated casing using the at least one heating element is carried out while the heat insulated casing is removed from the pressure vessel.

The step 107 is optional, and may be omitted, which is indicated by the dashed lines forming the element indicated by 107 in FIG. 4. That is, the heat insulated casing may be removed from the pressure vessel, but may not necessarily be placed in a container. For example, the heat insulated casing may, subsequently to having been removed from the pressure vessel, be placed on the floor or on some other supporting surface. Thus, in FIG. 4, the step 106 may be immediately followed by the step 108, with step 107 omitted.

If the step 107 is included, the heating of the at least a part or portion of the heat insulated casing using the at least one heating element while the heat insulated casing is removed from the pressure vessel at 108 may be carried out while the heat insulated casing is placed in the container. Thus, the step 108 may comprise, at 109, carrying out the heating of the at least a part or portion of the heat insulated casing using the at least one heating element while the heat insulated casing is placed in the container. The step 109 is optional, and may be omitted, which is indicated by the dashed lines forming the element indicated by 109 in FIG. 4.

At 110, subsequently to carrying out the heating of the at least a part or portion of the heat insulated casing using the at least one heating element at 108, the heat insulated casing is arranged in the pressure vessel.

If the step 107 is included, the step 110 may be preceded by removing the heat insulated casing from the container, at 111. If the step 107 is not included, the step 111 may be omitted, and the step 108 may be immediately followed by the step 110 without the step 111 therebetween. Thus, step 111 is optional, and may be omitted, which is indicated by the dashed lines forming the element indicated by 111 in FIG. 4.

It is to be understood that while according to FIG. 3 and the description relating thereto, the heating of at least a part or portion of the heat insulated casing such that any amount of moisture present in or on the at least a part or portion of the heat insulated casing is reduced is carried out using at least one heating element, different implementations or realizations are contemplated, which might be applied in alternative or in addition to use of at least one heating element. Two examples are illustrated in FIGS. 5 and 6, each of which may be applied in alternative or in addition to use of at least one heating element as described in the foregoing. The examples illustrated in FIGS. 5 and 6 could be used in combination, in alternative or in addition to use of at least one heating element as described in the foregoing.

FIG. 5 is a schematic flowchart illustrating a part of a method for a press apparatus, according to an embodiment of the present invention. FIG. 5 illustrates an exemplifying way of how the heating of at least a part or portion of the heat insulated casing using at least one heating means may be implemented or realized. Thus, FIG. 5 illustrates an exemplifying way of how step 101 in FIG. 2 may be implemented or realized.

As described in the foregoing, the press apparatus may comprise a pressure medium flow generator, which may be configured to generate a flow of pressure medium in the furnace chamber and the at least one pressure medium guiding passage. At 112, heated pressure medium is introduced into the pressure vessel. At 113, the pressure medium flow generator is operated to generate a flow of the heated pressure medium in the furnace chamber and the at least one pressure medium guiding passage during a selected period of time. The heated pressure medium may include an amount of thermal energy such that by transfer of thermal energy from the heated pressure medium to the at least a part or portion of the heat insulated casing during the passage of the heated pressure medium in the furnace chamber and the at least one pressure medium guiding passage and during the selected period of time, the at least a part or portion of the heat insulated casing is heated such that any amount of moisture present in or on the at least a part or portion of the heat insulated casing is reduced. The heated pressure medium may for example comprise or be constituted by pressure medium having been used in the press apparatus during a previous occasion of treatment using the press apparatus (which use may have resulted in a relatively high temperature of the pressure medium), which may have been heated prior to introduction into the pressure vessel. Such re-use of pressure medium may help in reducing the overall pressure medium consumption. The pressure medium having been used in the press apparatus during a previous occasion of treatment using the press apparatus might be (momentarily) stored in some intermediate or temporary pressure medium storage (e.g., a container, vessel, or reservoir). In alternative or in addition, the heated pressure medium may comprise pressure medium in some pressure medium storage (e.g., a container, vessel, or reservoir) which may be fluidly connected or connectable to the pressure vessel, which pressure medium may be heated before being introduced into the pressure vessel. The heating of the pressure medium may be carried out while the pressure medium is in the pressure medium storage or while the pressure medium is guided to the pressure vessel from the pressure medium storage, for example by means of heat exchanger(s) and/or heater(s) arranged in or on a pressure medium passage (e.g., piping) fluidly connecting the pressure medium storage and the pressure vessel.

FIG. 6 is a schematic flowchart illustrating a part of a method for a press apparatus, according to an embodiment of the present invention. FIG. 6 illustrates an exemplifying way of how the heating of at least a part or portion of the heat insulated casing using at least one heating means may be implemented or realized. Thus, FIG. 6 illustrates an exemplifying way of how step 101 in FIG. 2 may be implemented or realized.

The outer surface of a wall of the pressure vessel may be provided with a cooling medium circuit, which may extend along at least a portion of the outer surface. The cooling medium circuit may be configured to circulate a cooling medium therein. At 114, the the cooling medium is heated. At 115, the heated cooling medium is circulated in the cooling medium circuit during a selected period of time. The heating of the cooling medium at 114 may be carried out such that the heated cooling medium includes an amount of thermal energy such that by transfer of thermal energy from the heated cooling medium to the wall of the pressure vessel during the circulation of the heated cooling medium in the cooling medium circuit during the selected period of time, whereby thermal energy is transferred to the interior of the pressure vessel, the at least a part or portion of the heat insulated casing is heated such that any amount of moisture present in or on the at least a part or portion of the heat insulated casing is reduced. The heating of the cooling medium may for example be carried out such that the temperature of the cooling medium is in a range from (about) 40° C. to (about) 150° C., or from (about) 40° C. to (about) 120° C. It is to be understood that the steps 114 and 115 may be carried out in addition to the steps 112 and 113 and/or any other step(s) for implementing or realizing step 101 in FIG. 2 as disclosed herein. If the steps 114 and 115 are carried out in addition to any other step(s) for implementing or realizing step 101 in FIG. 2 as disclosed herein, the heating of the cooling medium may be relatively moderate, e.g., so that the temperature of the cooling medium is in a range from (about) 40° C. to (about) 60° C., or from (about) 40° C. to (about) 50° C. The heating of the cooling medium may for example be carried out by means of an immersion heater and a pump (e.g., a pump configured to circulate the cooling medium in the cooling medium circuit). If the cooling medium has been heated, it should be ensured that the temperature of the cooling medium is sufficiently decreased prior to carrying out any cooling phase of a treatment cycle, in order for the cooling phase not to be negatively affected by the temperature of the cooling medium being too high.

FIG. 7 is a schematic, in part sectional, side view of a system according to an embodiment of the present invention. The system comprises a press apparatus 90 and heating means 41, which will be described further in the following. It is to be understood that the system—which will be collectively referred to in the following by way of the reference numerals 41 and 90—may comprise additional parts, components or elements not illustrated in FIG. 7.

The press apparatus 90 is arranged for treatment of at least one article by means of pressing, for example by means of isostatic pressing such as hot isostatic pressing (HIP). The press apparatus 90 comprises a pressure vessel, which comprises a pressure cylinder 1 and a top end closure 8 and a bottom end closure 9, or more generally a first end closure and a second end closure, respectively (e.g., if the pressure vessel is not arranged along a vertical direction). While the end closures 8, 9 in the following may be referred to as a top (or upper) end closure and a bottom end closure, respectively, it is to be understood that such description does not limit the disclosed embodiments to a certain orientation of the pressure vessel in relation to, e.g., a vertical direction. Rather, the pressure vessel can be arranged, for example, along a vertical direction (which may be referred to as a vertically oriented pressure vessel), or along a horizontal direction (which may be referred to as a horizontally oriented pressure vessel), and even if the end closures 8, 9 in the following may be referred to as a top end closure and a bottom end closure, respectively, it is to be understood that the terms “top” and “bottom” does not restrict the orientation of the pressure vessel in relation to, e.g., a vertical direction in any way. It is to be understood that the pressure vessel—which will be collectively referred to in the following by way of the reference numerals 1, 8 and 9—may comprise additional parts, components or elements not illustrated in FIG. 7. The pressure vessel 1, 8, 9 is arranged to hold pressure medium therein during use of the press apparatus 90.

The pressure vessel 1, 8, 9 comprises a furnace chamber 18. The furnace chamber 18 is arranged within the pressure vessel 1, 8, 9 so that pressure medium can enter and exit the furnace chamber 18. The furnace chamber 18 may comprise a furnace, or heater or heating elements, for heating of the pressure medium in the pressure vessel 1, 8, 9 for example during a heating phase and/or a pressing phase of a treatment cycle. The furnace is schematically indicated in FIG. 7 by the reference numerals 14. Parts of the furnace 14 are illustrated in FIG. 7 as two identical elements indicated by the reference numerals 14. It is however to be understood that the furnace 14 could be provided in in principle any number of parts, and not only two parts as illustrated in FIG. 7, but fewer or more than two parts. In accordance with the embodiment of the present invention illustrated in FIG. 7, the furnace 14 is arranged at a lower part of the furnace chamber 18. It is to be understood that different configurations and arrangements of the furnace 14 in relation to, e.g., within, the furnace chamber 18 are possible. For example, in alternative or in addition to the arrangement of the furnace 14 illustrated in FIG. 7, the furnace 14 could be arranged at an upper part of the furnace chamber 18, such as, for example, in pressure medium guiding passage 32 shown in FIG. 7, and/or in the pressure medium guiding passage that is between the components labelled 4 and 19 in FIG. 7 (the bottom insulating portion and the load compartment, respectively, which are described further in the following).

Any implementation of the furnace 14 with regards to arrangement thereof in relation to, e.g., within, the furnace chamber 18 may be used in any one of the embodiments of the present invention disclosed herein. In the context of the present application, the term “furnace” refers to the elements or means for providing heating, while the term “furnace chamber” refers to the area or region in which the furnace and possibly a load compartment and any article are located. As illustrated in FIG. 7, the furnace chamber 18 may not occupy the whole inner space of the pressure vessel 1, 8, 9, but may leave an intermediate space 10 of the interior of the pressure vessel 1, 8, 9 around the furnace chamber 18. The intermediate space 10 forms a pressure medium guiding passage 10. During operation of the press apparatus 90, the temperature in the intermediate space 10 may be lower than the temperature in the furnace chamber 18, but the intermediate space 10 and the furnace chamber 18 may be at equal, or substantially equal, pressure.

The press apparatus 90 comprises a heat insulated casing arranged within the pressure vessel 1, 8, 9. The heat insulated casing, which will be collectively referred to in the following by way of the reference numerals 2 and 7, is arranged so that pressure medium can enter and exit the furnace chamber 18. In accordance with the embodiment of the present invention illustrated in FIG. 7, the heat insulated casing 2, 7 comprises a heat insulating portion 7, which partly encloses the furnace chamber 18, and a housing 2, which partly encloses the heat insulating portion 7. The heat insulating portion 7 may in alternative be referred to as a heat insulating layer. The heat insulated casing 2, 7 may in alternative be referred to as a furnace mantle. The heat insulated casing 2, 7 may further comprise a bottom insulating portion 4. The bottom insulating portion 4 may in alternative be referred to as a furnace base. However, the bottom insulating portion 4 may possibly not be considered as a part of the heat insulated casing 2, 7. For example, the heat insulating portion 7 and the housing 2 may, possibly as an aggregation or unit, be removably arranged in the pressure vessel 1, 8, 9, such that they can be at least temporarily removed from the pressure vessel 1, 8, 9, whereas the bottom insulating portion 4 may not be removably arranged in the pressure vessel 1, 8, 9. The bottom insulating portion 4 may however be removably arranged in the pressure vessel 1, 8, 9. If the bottom insulating portion 4 is not removably arranged in the pressure vessel 1, 8, 9 but the heat insulating portion 7 and the housing 2 are removably arranged in the pressure vessel 1, 8, 9, the bottom insulating portion 4 may not be considered as a part of the heat insulated casing 2, 7. Otherwise, the bottom insulating portion 4 could be considered as a part of the heat insulated casing 2, 7. However, each or any of the heat insulating portion 7, the housing 2 and the bottom insulating portion 4 may be separately removably arranged in the pressure vessel 1, 8, 9. Thus, not all of the heat insulating portion 7, the housing 2 and the bottom insulating portion 4 need to be removably arranged in the pressure vessel 1, 8, 9 as an aggregation or unit.

It is to be understood that the realization or implementation of the heat insulated casing 2, 7 illustrated in FIG. 7 and in the other figures is according to an example, and that other realizations or implementations of the heat insulated casing are possible.

According to one example, the heat insulated casing 2, 7 may comprise a layered structure (not shown in FIG. 7) having an outer layer, an intermediate layer (or several) and an inner layer, with the intermediate layer arranged between the outer layer and the inner layer, and with heat insulation material arranged between the intermediate layer and the inner layer. The outer layer may be constituted by the housing 2, the inner layer may define the inner surface of the heat insulating portion 7, and the intermediate layer may define the outer surface of the heat insulating portion 7. The heat insulation material may for example be sandwiched between the intermediate layer and the inner layer. Each or any of the outer layer, the intermediate layer and the inner layer may for example be made of steel or steel-based material, molybdenum or a molybdenum-based material, and/or carbon or a carbon-based material, such as, for example, graphite. According to one example, the outer layer and the intermediate layer may be made of steel, and the inner layer may be made of molybdenum. The heat insulation material may for example be constituted or comprise one or more ceramic fiber materials, such as, for example, Saffil, MAFTEC polycrystalline alumina fiber materials, superwool, and/or one or more other types of ceramic materials, or any combination thereof. Between the outer layer and the intermediate layer and/or between the intermediate layer and the inner layer there may be provided spacers, e.g., comprising so called angle irons, for spacing the layers from each other. The intermediate layer may be provided with one or more holes or openings allowing for passage of, e.g., pressure medium therethrough.

The pressure vessel 1, 8, 9 includes a treatment region therein. The treatment region may for example be at least in part defined by the furnace chamber 18. For example, the treatment region may be comprised or constituted by an interior of the furnace chamber 18. The treatment region is arranged to accommodate an article 5 (or possibly several articles) therein. In accordance with the embodiment of the present invention illustrated in FIG. 7, a load compartment 19, which is included in the furnace chamber 18, is arranged to accommodate the article 5 therein. In accordance with the embodiment illustrated in FIG. 7, the load compartment 19 may be defined or formed by the interior of a load basket. Thus, the load compartment 19 may be defined by a load basket configured to hold the article(s) 5. The load basket may be fixedly arranged on the bottom insulating portion 4, or releasably arranged on the bottom insulating portion 4 (i.e. so that it can be arranged on the bottom insulating portion 4 and subsequently (relatively easily) removed from the bottom insulating portion 4). The treatment region may be comprised or constituted by an interior of the load compartment 19. The press apparatus 90 is configured to subject the article 5 to treatment.

It is to be understood that not all of the elements of the heat insulated casing 2, 7 may be arranged so as to be heat insulated or heat insulating. For example, the housing 2 may not necessarily be arranged so as to be heat insulated or heat insulating. The heat insulated casing 2, 7 surrounding the furnace chamber 18 is likely to save energy during a heating phase of the treatment cycle to which the press apparatus 90 may be configured to subject the article 5 to. The heat insulated casing 2, 7 may also facilitate or ensure that convection takes place in a more ordered manner. Because of the vertically elongated shape of the furnace chamber 18 in the illustrated embodiment of the present invention, the heat insulated casing 2, 7 may prevent forming of temperature gradients, such as horizontal temperature gradients, which may be difficult to monitor and control.

The arrows within the pressure vessel 1, 8, 9 in FIG. 7 indicate exemplifying flows of pressure medium within the pressure vessel 1, 8, 9 in use of the press apparatus 90, e.g., during treatment of the article(s) 5 using the press apparatus 90, such as, for example, during a cooling phase of a treatment cycle.

The heat insulated casing 2, 7 comprises a pressure medium guiding passage 11, which is formed between portions of the housing 2 and the heat insulating portion 7, respectively. The pressure medium guiding passage 11 is arranged to, in use of the press apparatus 90, guide pressure medium that has exited the furnace chamber 18 towards the first end closure (e.g., top end closure) 8 such that pressure medium having exited the pressure medium guiding passage 11 can be guided in proximity to an inner surface 23 of a wall(s) 22 of the pressure vessel 1, 8, 9. More particularly, in accordance with the embodiment of the present invention illustrated in FIG. 7, the pressure medium guiding passage 11 is arranged to guide the pressure medium after having exited the furnace chamber 18 to a space 17 between the top end closure 8 and the furnace chamber 18.

Further in accordance with the embodiment of the present invention illustrated in FIG. 7, the pressure medium guiding passage 11 forms a part of an outer convection loop. Another part of the outer convection loop comprises the intermediate space 10 of the interior of the pressure vessel 1, 8, 9 around the furnace chamber 18, which may be referred to as the pressure medium guiding passage 10. The pressure medium guiding passage 10 is arranged to guide the pressure medium from the space 17 between the top end closure 8 and the furnace chamber 18 in proximity to the inner surface 23 of wall(s) 22 of the pressure vessel 1, 8, 9 to a space 16 between the bottom insulating portion 4 and the bottom end closure 9. The pressure medium guiding passages 10 and 11 are hence in fluid communication with the furnace chamber 18, and are arranged to form at least a part of an outer convection loop within the pressure vessel 1, 8, 9. The outer convection loop is arranged to guide the pressure medium after having exited the furnace chamber 18 in proximity to an inner surface 23 of wall(s) 22 of the pressure vessel 1, 8, 9 to a space 16 between the furnace chamber 18 and the bottom end closure 9. As indicated in FIG. 7, the wall(s) 22 of the pressure vessel 1, 8, 9 may be the outer wall(s) of the pressure vessel 1, 8, 9.

As indicated in FIG. 7, the pressure medium may exit the load compartment 19 at a top portion thereof and subsequently be guided in a pressure medium guiding passage 32 between the walls of the load compartment 19 and the heat insulating portion 7, after which the pressure medium may enter into the pressure medium guiding passage 11 by way of opening(s) 6 between the heat insulating portion 7 and the housing 2. The opening(s) 6 between the heat insulating portion 7 and the housing 2 may be at or approximately at the level of the bottom insulating portion 4, as illustrated in FIG. 7. It is however to be understood that the opening(s) 6 between the heat insulating portion 7 and the housing 2 may be at a different location than illustrated in FIG. 7. This applies to any of the disclosed embodiments of the present invention, such as the embodiments of the present invention illustrated in the figures.

The pressure medium that enters into the pressure medium guiding passage 11 by way of the opening(s) between the heat insulating portion 7 and the housing 2 is guided in the pressure medium guiding passage 11 towards the top end closure 8 where it may exit the pressure medium guiding passage 11 and the heat insulated casing 2, 7 by way of an opening in the housing 2, e.g., a central opening in the housing 2, as illustrated in FIG. 7.

A pressure medium guiding passage defined by the space 17 in part defined by the inner surface of the top end closure 8 and the pressure medium guiding passage 10 is arranged to guide the pressure medium having exited the opening in the housing 2 in proximity to the top end closure 8 and in proximity to an inner surface 23 of wall(s) 22 of the pressure vessel 1, 8, 9 (e.g., the wall(s) of the pressure cylinder 1, respectively, as illustrated in FIG. 7) to the space 16 between the furnace chamber 18 and the bottom end closure 9.

It is to be understood that FIG. 7 illustrates an exemplifying embodiment of the present invention, and that variations are possible, e.g., with respect to how the pressure medium is guided within the pressure vessel 1, 8, 9. For example, between the opening in the housing 2 and the upper part of the heat insulating portion 7 there could be provided a heat absorbing element as disclosed in WO 2018/171884 A1, such as a heat absorbing body indicated by reference numeral 20 and as illustrated in the figures in WO 2018/171884 A1. In alternative or in addition, there could for example be provided a heat exchanging element as disclosed in WO 2019/149379 A1 arranged in the top end closure 8, such as a heat exchanging element indicated by reference numeral 170 and as illustrated in the figures in WO 2019/149379 A1.

Even though it is not explicitly indicated in FIG. 7, the pressure vessel 1, 8, 9 may be arranged such that it can be opened and closed, such that any article within the pressure vessel 1, 8, 9 may be inserted into or removed from the pressure vessel 1, 8, 9, possibly such that the heat insulated casing 2, 7 (and possibly also the bottom insulating portion 4) may be inserted into or removed from the pressure vessel 1, 8, 9. An arrangement of the pressure vessel 1, 8, 9 such that it can be opened and closed may be realized in a number of different manners, as known in the art. Although not explicitly indicated in FIG. 7, one or both of the top end closure 8 and the bottom end closure 9 may be arranged so that it or they can be opened and closed, so that any article within the pressure vessel 1, 8, 9 may be inserted into or removed from the pressure vessel 1, 8, 9, and possibly such that the heat insulated casing 2, 7 (and possibly also the bottom insulating portion 4) may be inserted into or removed from the pressure vessel 1, 8, 9, via one or both of the top end closure 8 and the bottom end closure 9. Thus, article(s) may be loaded into and unloaded from the pressure vessel 1, 8, 9 via one or both of the top end closure 8 and the bottom end closure 9.

The pressure medium used in the pressure vessel 1, 8, 9 or press apparatus 90 may for example comprise or be constituted by a liquid or gaseous medium which may have a relatively low chemical affinity in relation to the article(s) to be treated in the pressure vessel 1, 8, 9. The pressure medium may for example comprise a gas, for example an inert gas such as Argon gas.

The outer surface of the outer walls of the pressure vessel 1, 8, 9 may be provided with channels, conduits or tubes, etc. (not shown in FIG. 7), which channels, conduits or tubes for example may be arranged so as to be in connection with the outer surface of the outer wall of the pressure vessel 1, 8, 9, and which may be arranged to run parallel to an axial direction of the pressure vessel 1, 8, 9 or helically or spirally around the outer surface of the outer wall of the pressure vessel 1, 8, 9. A coolant, or cooling medium, for cooling of the walls of the pressure vessel 1, 8, 9 may be provided in the channels, conduits or tubes, whereby the walls of the pressure vessel 1, 8, 9 may be cooled in order to protect the walls from detrimental heat building up during operation of the pressure vessel 1, 8, 9. The coolant in the channels, conduits or tubes may for example comprise water, but another or other types of coolants are possible. An exemplifying flow of coolant in channels, conduits or tubes provided on the outer surface of the outer walls of the pressure vessel 1, 8, 9 is indicated in FIG. 7 by the arrows on the outside of the pressure vessel 1, 8, 9.

On the outer surface of the outer walls of the pressure cylinder 1, and possibly on any channels, conduits and/or tubes, etc. for coolant as described in the foregoing, pre-stressing means may be provided. The pre-stressing means (not shown in FIG. 7) may for example be provided in the form of wires (e.g., made of steel) wound in a plurality of turns so as to form one or more bands, and preferably in several layers, around the outer surface of the outer walls of the pressure cylinder 1 and possibly also any channels, conduits and/or tubes, etc. for coolant that may be provided thereon. The pre-stressing means may be arranged for exerting radial compressive forces on the pressure cylinder 1.

As described in the foregoing, an outer convection loop may be formed by at least the pressure medium guiding passage 10 and the pressure medium guiding passage 11. In a part of the outer convection loop, the pressure medium is guided in proximity to the inner surface of the top end closure 8 and the inner surface 23 of wall(s) 22 of the pressure vessel 1, 8, 9, or pressure cylinder 1. The amount of thermal energy which may be transferred from the pressure medium during its passage in proximity to inner surfaces of the top end closure 8 and the inner surface 23 of walls 22 of the pressure vessel 1, 8, 9, or the pressure cylinder 1, may depend on at least one of the following: the speed of the pressure medium, the amount of pressure medium having (direct) contact with the inner surface of the top end closure 8 and the inner surface 23 of walls 22 of the pressure vessel 1, 8, 9, or the pressure cylinder 1, the relative temperature difference between the pressure medium and the inner surface of the top end closure 8 and the inner surface 23 of walls 22 of the pressure vessel 1, 8, 9, or the pressure cylinder 1, the thickness of the top end closure 8 and the thickness of walls 22 of the pressure vessel 1, 8, 9, or the pressure cylinder 1, and the temperature of any flow of coolant in channels, conduits or tubes provided on the outer surface of walls 22 of the pressure vessel 1, 8, 9, or the pressure cylinder 1 (indicated in FIG. 7 by the arrows on the outside of the pressure cylinder 1).

The pressure medium that is guided in the pressure medium guiding passage 10 back towards the furnace chamber 18 enters the space 16 between the furnace chamber 18—or the bottom insulating portion 4—and the bottom end closure 9. The furnace chamber 18 may be arranged so that pressure medium can enter the furnace chamber 18 from, and exit the furnace chamber 18 into, the space 16. For example, and in accordance with the embodiment of the present invention illustrated in FIG. 7, the furnace chamber 18 may be provided with an opening in the bottom insulating portion 4 permitting pressure medium to flow into (or out of) the furnace chamber 18. Further in accordance with the embodiment of the present invention illustrated in FIG. 7, a pressure medium guiding passage 12, e.g., comprising a conduit 12, is arranged so as to extend through the bottom insulating portion 4, with a lower (or first) opening of the pressure medium guiding passage or conduit 12 below the bottom insulating portion 4 (and possibly within the space 16, as per the illustrated embodiment) and an upper (or second) opening of the pressure medium guiding passage or conduit 12 at an upper surface of the bottom insulating portion 4 (and possibly aligned with an opening in the load compartment 19, as per the illustrated embodiment). The lower (or first) opening of the pressure medium guiding passage or conduit 12 may for example be provided with adjustable pressure medium flow restriction means such as one or more adjustable throttles or valves. Possibly, the upper (or second) opening of the pressure medium guiding passage or conduit 12 could be at a distance from the upper surface of the bottom insulating portion 4, possibly within the furnace chamber 18 or load compartment 19. Thus, the pressure medium guiding passage or conduit 12 might extend into the furnace chamber 18 or load compartment 19 (not illustrated in FIG. 7).

The pressure medium guiding passage 32 of the furnace chamber 18 and the pressure medium guiding passage formed between the load compartment 19 and the bottom insulating portion 4 are in fluid communication with the load compartment 19 so as to in part form an inner convection loop, wherein pressure medium in the inner convection loop is guided through the load compartment 19 and through the pressure medium guiding passage 32 of the furnace chamber 18 and the pressure medium guiding passage formed between the load compartment 19 and the bottom insulating portion 4 and back to the load compartment 19, or vice versa. The direction of the pressure medium flow in the inner convection loop, e.g., during a heating phase, may depend on whether the furnace chamber is a natural convection furnace chamber or a forced convection furnace chamber.

In accordance with the embodiment of the present invention illustrated in FIG. 7, the press apparatus 90 comprises a pressure medium circulation flow generator 15, which is configured to provide a circulation of pressure medium within the pressure vessel 1, 8, 9, wherein during the circulation of the pressure medium, the pressure medium passes through the furnace chamber 18. The pressure medium circulation flow generator 15 is optional and may be omitted. In accordance with the embodiment of the present invention illustrated in FIG. 7, the pressure medium circulation flow generator 15 comprises a fan 15 or the like (or several fans or the like) for circulation of pressure medium within the furnace chamber 18. In alternative or in addition, the pressure medium circulation flow generator 15 could comprise another or other types of pressure medium circulation flow generators than a fan, such as, for example, one or more ejectors. Further in accordance with the embodiment of the present invention illustrated in FIG. 7, the pressure medium circulation flow generator 15 may for example be arranged at an opening in the load compartment 19 above the bottom insulating portion 4, which openings permits pressure medium flow into or out of the load compartment 19. The pressure medium circulation flow generator 15 may be controllable at least with respect to operating rate thereof. The operating rate of the pressure medium circulation flow generator 15 could for example comprise a number of revolutions per minute (rpm) of the pressure medium circulation flow generator 15, such as if it comprises or is constituted by one or more fans, etc., but another or other types of operating rates are contemplated, depending on the nature of the particular implementation of the pressure medium circulation flow generator 15. The pressure medium circulation flow generator 15 may be configured to selectively control the flow rate of pressure medium in the above-mentioned inner convection loop.

The press apparatus 90 may comprise a pressure medium flow generator 13 arranged within the pressure vessel 1, 8, 9 and in fluid communication with the furnace chamber 18. For example during a cooling phase of the treatment cycle, the pressure medium flow generator 13 may be arranged to generate a transport of pressure medium from at least the space 16 between the furnace chamber 18 and the bottom end closure 4 into the furnace chamber 18 so as to cool the pressure medium in the treatment region.

According to the embodiment of the present invention illustrated in FIG. 7, the pressure medium flow generator 13 comprises an ejector arrangement 13, which is only schematically illustrated in FIG. 7. As illustrated in FIG. 7, pressure medium from the pressure medium guiding passage 10 which enters the space 16 may be drawn into the pressure medium flow generator 13 and subsequently be ejected from the flow generator 13 into the pressure medium guiding passage or conduit 12, which may then transport the pressure medium to the furnace chamber 18. The pressure medium flow generator 13—for example comprising an ejector arrangement 13—may comprise a single stage ejector, or a multi-stage ejector (e.g., a two-stage ejector, such as the primary and secondary ejectors indicated by reference numerals 51 and 52, respectively, and as illustrated in FIG. 3 in U.S. Pat. No. 10,458,711 B2). By a single-stage ejector, it is meant that the pressure medium flow generator 13 or ejector arrangement 13 comprises one flow generator or ejector. By a multi-stage ejector, it is meant that the pressure medium flow generator 13 or ejector arrangement 13 comprises a plurality of flow generators or ejectors, which are arranged so that the output from at least one flow generator or ejector is input to another flow generator or ejector. The plurality of flow generators or ejectors may for example be arranged in series. For example, the pressure medium flow generator 13 or ejector arrangement 13 may comprise a primary flow generator or ejector and a secondary flow generator or ejector, wherein the primary flow generator or ejector is arranged to draw pressure medium from the pressure medium guiding passage 10 which enters the space 16 into the primary flow generator or ejector. The output from the primary flow generator or ejector may be input into the secondary flow generator or ejector, and the output from the secondary flow generator or ejector may be ejected into the pressure medium guiding passage or conduit 12. In alternative or in addition, the pressure medium flow generator 13 could for example comprise one or more fans, pumps, or the like, which may be arranged to cause a flow of pressure medium into the pressure medium guiding passage or conduit 12. The pressure medium flow generator 13 or ejector arrangement 13 may be connected to a propellant medium system (not illustrated in FIG. 7), e.g., a propellant gas system, which may be arranged outside the pressure vessel 1, 8, 9. The pressure medium flow generator 13 or ejector arrangement 13 may for example be connected to a propellant medium system via a pipe or the like extending through the bottom end closure 9 (or second end closure). For example, any primary flow generator or ejector of the pressure medium flow generator 13 or ejector arrangement 13 may be connected to such a propellant medium system. The medium from such a propellant medium system may in part drive the pressure medium flow generator 13 or ejector arrangement 13. For example, the medium from such a propellant medium system may in part drive any primary flow generator or ejector of the pressure medium flow generator 13 or ejector arrangement 13.

As mentioned in the foregoing, the arrows within the pressure vessel 1, 8, 9 in FIG. 7 indicate exemplifying flows of pressure medium within the pressure vessel 1, 8, 9 in use of the press apparatus 90, e.g., during treatment of the article(s) 5 using the press apparatus 90, such as, for example, during a cooling phase of a treatment cycle.

As also mentioned in the foregoing, in addition to the press apparatus 90, the system 41, 90 comprises heating means 41. The heating means 41 are used prior to carrying out treatment of the article(s) 5 using the press apparatus 90. Prior to carrying out treatment of the article(s) 5 using the press apparatus 90, there may be no flow of pressure medium in the pressure vessel 1, 8, 9 (e.g., no flow of pressure medium in the pressure vessel 1, 8, 9 as indicated by the arrows within the pressure vessel 1, 8, 9 in FIG. 7), and the pressure medium might even not yet have been introduced into the pressure vessel 1, 8, 9.

The heating means 41 is configured to, prior to carrying out the treatment of the article(s) 5 using the press apparatus 90, heat at least a part or portion of the heat insulated casing 2, 7 such that any amount of moisture present in or on the at least a part or portion of the heat insulated casing 2, 7 is reduced. For example, by heating at least a part or portion of the heat insulated casing 2, 7, water and/or another or other liquids may be released, vaporized (e.g., evaporated) and/or diffused from one or more surfaces of the heat insulated casing 2, 7. Resulting water in gas phase (e.g., water vapor) and/or other gas may then be removed from the heat insulated casing 2, 7, for example by means of (e.g., actively) withdrawing it/them from the heat insulated casing 2, 7 or the pressure vessel 1, 8, 9 by, e.g., performing one or more vacuum phases of a treatment cycle, which may be carried out by means of one or more vacuum pumps (not shown in FIG. 7). In, e.g., a heating phase of a treatment cycle, pressure medium may be guided, or pushed, through the pressure medium guiding passage 11 by means of operation of the pressure medium flow generator 13, possibly in combination with operation of the pressure medium circulation flow generator 15.

In accordance with the embodiment of the present invention illustrated in FIG. 7, the heating means 41 comprise heating elements 41 arranged within the heat insulated casing 2, 7. For example, the heating elements 41 may be arranged in the pressure medium guiding passage 11, as illustrated in FIG. 7. Only some of the heating elements 41 are indicated by reference numeral 41 in FIG. 7. It is to be understood that the number of heating elements in FIG. 7 is exemplifying, and that the number of heating elements may be smaller or larger than illustrated in FIG. 7. The heating elements 41 may be used to heat one or more outer and/or inner surfaces of the heat insulated casing 2, 7. In alternative or in addition, the heating element 41 may be arranged at other positions in the pressure vessel than illustrated in FIG. 7. For example, in alternative or in addition, the heating element 41 may be arranged in the pressure medium guiding passage 32.

The heating elements 41 may be operable to generate heat at a selected output power. The heating elements 41 may be used to heat at least a part or portion of the heat insulated casing 2, 7 at a selected output power of the heating elements 41 and during a selected period of time. The output power of the heating elements 41 and the period of time may be selected such that any amount of moisture present in or on the at least a part or portion of the heat insulated casing 2, 7 is reduced. The output power of the heating elements 41 may be selected such that a certain temperature in the furnace chamber 18, in the pressure medium guiding channel 11 (e.g., at the heating elements 41), in the space between the top end closure 8 and the housing 2, or in the space 16, is achieved (but possibly not exceeded). Once such temperature(s) has/have been achieved, which may be ascertained by means of one or more temperature sensors such as thermocouples, it may be considered that the at least a part or portion of the heat insulated casing 2, 7 has been heated sufficiently long, such that any amount of moisture present in or on the at least a part or portion of the heat insulated casing 2, 7 should not exceed a certain (e.g., a selected, or predefined) threshold level of amount of moisture in the at least a part or portion of the heat insulated casing 2, 7. Thus, the heating elements 41 may be used to heat at least a part or portion of the heat insulated casing 2, 7 at a selected output power of the heating elements 41 and during a selected period of time such that a certain temperature at one or more selected regions in the pressure vessel (e.g., at one or more selected components in or of the pressure vessel) is achieved, after which the operation of the heating elements 41 may be stopped or interrupted.

It is to be noted that, in addition or in alternative, the heating means could comprise the furnace 14, and that the heating elements 41 might be a part of the furnace. In alternative or in addition, the heating elements 41 could, as mentioned in the foregoing, be arranged in the pressure medium guiding passage 32, for example. The system 41, 90 could possibly include additional heating means, which may not necessarily be heating elements but may be of another type.

The press apparatus 90 is configured to, subsequently to the heating of the at least a part or portion of the heat insulated casing 2, 7 using the heating elements 41, carry out the treatment of the article(s) 5 using the press apparatus 90.

In order to ensure that any amount of moisture present in or on the at least a part or portion of the heat insulated casing 2, 7 is reduced (e.g., so as to not exceed a certain threshold level of amount of moisture in the at least a part or portion of the heat insulated casing 2, 7), and/or that the concentration of any water vapor in the pressure medium used in the press apparatus 90 during the treatment does not exceed a certain (e.g., a selected, or predefined) threshold concentration level, a moisture sensor and/or an oxygen sensor may be used.

The moisture sensor and/or oxygen sensor (and/or a sensor of any other appropriate type) may be configured to sense amount of moisture directly or indirectly in pressure medium used in the pressure vessel 1, 8, 9 during treatment. The moisture sensor and/or oxygen sensor (and/or a sensor of any other appropriate type) may be configured to sense amount of moisture indirectly by sensing some quantity/quantities from which the amount of moisture is derived or derivable.

The moisture sensor and/or oxygen sensor (and/or a sensor of any other appropriate type) may for example be configured to sense amount of moisture directly or indirectly in the pressure medium within the heat insulated casing 2, 7 (e.g., in the furnace chamber 18, in the load compartment 19, or in an interior of the heat insulating portion 7) during treatment. This allows or facilitates for ensuring that the concentration of any water vapor in the pressure medium within the heat insulated casing 2, 7 during the treatment does not exceed a certain threshold concentration level.

In accordance with the embodiment of the present invention illustrated in FIG. 7, the moisture sensor and/or oxygen sensor (and/or a sensor of any other appropriate type), schematically indicated at 35 in FIG. 7, may be arranged in the furnace chamber 18. However, it is to be understood that the moisture sensor and/or oxygen sensor 35 may, in alternative or in addition, for example be arranged elsewhere within the furnace chamber 18 than illustrated in FIG. 7, or elsewhere within the heat insulated casing 2, 7 (e.g., in the load compartment 19, in the pressure medium guiding passage 11, and/or in an interior of the heat insulating portion 7 of the heat insulated casing 2, 7), or elsewhere within the pressure vessel 1, 8, 9. It is to be understood that the positions of the moisture sensor and/or oxygen sensor 35 (and/or a sensor of any other appropriate type) discussed herein relate to the position at which the sensor senses moisture and/or oxygen (and/or another substance), which may be referred to as the measurement position. Parts of the sensor (e.g., circuitry, wiring, etc.) may be arranged at other positions, possibly outside the pressure vessel 1, 8, 9.

A moisture sensor and/or oxygen sensor such the one illustrated in FIG. 7 may be included in any of the embodiments of the present invention disclosed herein.

A pressure medium diverting device (not shown in FIG. 7) may be provided, which may be configured to divert a portion of the pressure medium from, e.g., a space within the heat insulated casing 2, 7 (e.g., in the furnace chamber 18), to a pressure medium analyzing device, which may be arranged outside the pressure vessel 1, 8, 9. The pressure medium analyzing device (not shown in FIG. 7) may for example comprise a device for analyzing the composition (e.g., the chemical composition) of the pressure medium diverted by the pressure medium diverting device. The pressure medium analyzing device could also provide the functionality of moisture sensor and/or oxygen sensor 35, in which case the moisture sensor and/or oxygen sensor 35 illustrated in FIG. 7 could be omitted. The pressure medium diverting device may for example comprises one or more pressure medium guiding passages or conduits coupled to the pressure medium analyzing device, and may for example be arranged so as to extend through the end closure 9, the bottom insulating portion 4 and into the furnace chamber 18, in order to be able to divert a portion of the pressure medium from within the furnace chamber 18 to the pressure medium analyzing device.

FIG. 8 is a schematic, in part sectional, side view of a system 41, 90 according to an embodiment of the present invention. The system 41, 90 comprises a press apparatus 90 and heating means 41. The system 41, 90 illustrated in FIG. 8 is similar to the system 41, 90 illustrated in FIG. 7, and the same reference numerals in FIGS. 7 and 8 denote the same or similar components, having the same or similar function. Compared to the system 41, 90 illustrated in FIG. 7, in the system 41, 90 illustrated in FIG. 8, the heating elements 41 are arranged in different positions within the heat insulated casing 2, 7. Only some of the heating elements 41 are indicated by reference numeral 41 in FIG. 8. It is to be understood that the number of heating elements in FIG. 8 is exemplifying, and that the number of heating elements may be smaller or larger than illustrated in FIG. 8. As illustrated in FIG. 8, the heating elements 41 are arranged in an interior of the heat insulating portion 7, and may be arranged in (e.g., embedded in) the material(s) constituting the heat insulating portion 7. The material(s) constituting the heat insulating portion 7 may for example comprise or be constituted by one or more ceramic fiber materials, such as, for example, Saffil, MAFTEC polycrystalline alumina fiber materials, superwool, and/or one or more other types of ceramic materials, or any combination thereof (this also applies to the heat insulating portion 7 illustrated in FIG. 7). In alternative or in addition, the material(s) constituting the heat insulating portion 7 may for example comprise one or more graphite-based elements, such as, for example, one or more graphite blankets. The heating elements 41 may for example be used to heat at least a part or portion of the material(s) constituting the heat insulating portion 7. The system 41, 90 could possibly include additional heating means, such as heating elements that may be arranged in the pressure medium guiding passage 11, as illustrated in FIG. 7, and/or heating means which may not necessarily be heating elements but may be of another type.

With reference to FIGS. 7 and 8, each or any heating element 41 may for example comprise one or more metallic resistance heating elements, e.g., in the form of one or more wires and/or ribbons. One or more temperature sensors (e.g., one or more thermocouples) may be provided at each or any heating element 41 to ensure that the material(s) constituting the heat insulating portion 7 or the heating element(s) do or does not become subjected to a temperature exceeding any maximally allowed temperature the material(s) constituting the heat insulating portion 7 or heating element(s) is or are allowed to be subjected to by the operation of the heating element(s).

As described in the foregoing such as with reference to FIG. 4, the heating of the at least a part or portion of the heat insulated casing 2, 7 might be carried out while the heat insulated casing 2, 7 is removed from the pressure vessel 1, 8, 9. With reference to any of the disclosed embodiments, the heat insulated casing may be removably arranged in the pressure vessel, such that the heat insulated casing can be at least temporarily removed from the pressure vessel. This may—apart from the heating of the at least a part or portion of the heat insulated casing—be done for example for placing or replacing article(s) in the furnace chamber prior to carrying out treatment of the article(s) using the press apparatus, or for removing article(s) from the furnace chamber after completion of treatment of the article(s) using the press apparatus. When or whenever the heat insulated casing is removed from the pressure vessel, the heat insulated casing may be placed in a container arranged to accommodate the heat insulated casing. The container may comprise or be constituted by support construction arranged to support the heat insulating casing after it has been taken out of the pressure vessel. Embodiments of the present invention employing such a container will be described in the following with reference to FIGS. 9, 10 and 11, each of which is a schematic, in part sectional, side view of parts of a system in accordance with an embodiment of the present invention, including heating means and a heat insulated casing of a press apparatus.

FIG. 9 illustrates a heat insulated casing 2, 7 as described with reference to and illustrated in FIG. 7, wherein heating means comprising heating elements 41 are arranged within the heat insulated casing 2, 7. More specifically, according to the embodiment of the present invention illustrated in FIGS. 7 and 9, the heating elements 41 are arranged in the pressure medium guiding passage 11, at an outer surface of the heat insulating portion 7. In alternative or in addition, the heating elements could be arranged for example at an inner surface of the heat insulating portion 7. It is to be understood that not all of the components that are indicated by reference numerals in FIG. 7 are indicated by reference numerals in FIG. 9.

FIG. 9 illustrates a situation in which the heat insulated casing 2, 7 has been removed from the pressure vessel of the press apparatus and placed in a container 50 arranged to accommodate the heat insulated casing 2, 7. The container 50 may comprise several interconnected parts, as indicated in FIG. 9, or may be constituted by a single piece or part.

As illustrated in FIG. 9, the furnace chamber 18, which is partly enclosed by the heat insulating portion 7 of the heat insulated casing 2, 7, and which includes the furnace 14 and the load compartment 19, and the pressure medium circulation flow generator 15 may also be removably arranged in the pressure vessel, such that also those components may be at least temporarily removed from the pressure vessel. However, possibly only the heat insulated casing 2, 7 may be removably arranged in the pressure vessel, such that only the heat insulated casing 2, 7 may be at least temporarily removed from the pressure vessel, and not, even though illustrated in FIG. 9, the furnace chamber 18, the furnace 14, the load compartment 19 and the pressure medium circulation flow generator 15. In addition to the heat insulated casing 2, 7, the bottom insulating portion 4 and possibly the flow generator 13 and the pressure medium guiding passage or conduit 12 (not shown in FIG. 9; cf. FIGS. 7 and 8) may also be removably arranged in the pressure vessel, such that also those components may be at least temporarily removed from the pressure vessel.

Thus, FIG. 9 illustrates an example where the heating of the at least a part or portion of the heat insulated casing 2, 7 can be carried out while the heat insulated casing 2, 7 is removed from the pressure vessel 1, 8, 9, for example when the heat insulated casing 2, 7 is placed in the container 50 illustrated in FIG. 9. According to the embodiment of the present invention illustrated in FIG. 9, the heating of the at least a part or portion of the heat insulated casing 2, 7 can be carried out using heating means comprising heating elements 41 arranged within the heat insulated casing 2, 7, such as described in the foregoing with reference to FIG. 7. The heating elements 41 could possibly be a part of the furnace. Thus, the existing furnace of the furnace chamber 18 could possibly be used to carry out the preheating—i.e. the heating of at least a part or portion of the heat insulated casing 2, 7 carried out prior to carrying out the treatment of the article(s) using the press apparatus. The heating elements 41 may hence not necessarily be additional and/or separate heating element(s) dedicated for the preheating.

The container 50 could include or be coupled to an electric power supply (e.g., a battery or a power grid), and may permit for conveying power to the heating elements 41, for example by means of wiring and/or cables (not shown in FIG. 9) that may be comprised in the container 50 and that may be connected to the heating elements 41. Further, the container 50 may include wiring and/or cables for connection to one or more temperature sensors, such as, for example, one or more thermocouples or the like, which may be arranged such that it or they can sense temperature at for example the heating elements 41.

Thus, in accordance with the embodiment of the present invention illustrated in FIG. 9, subsequently to removing the heat insulated casing 2, 7 from the pressure vessel, the heat insulated casing 2, 7 may be placed in the container 50. The heating of the at least a part or portion of the heat insulated casing 2, 7 using the heating elements 41 is carried out while the heat insulated casing 2, 7 is placed in the container 50. Subsequently to carrying out the heating of the at least a part or portion of the heat insulated casing 2, 7 using the heating elements 41, the heat insulated casing 2, 7 may be removed from the container 50, and subsequently the heat insulated casing 2, 7 may be arranged in the pressure vessel. Treatment of the article(s) using the press apparatus may then be carried out.

The heating elements 41 could, in alternative or in addition, be arranged at an inner surface of the heat insulating portion 7. In that case, one or more flow generators (e.g., one or more fans or the like) could be provided and used to transfer heat generated by any heating element arranged at an inner surface of the heat insulating portion 7 into the pressure medium guiding passage 11.

FIG. 10 illustrates a heat insulated casing 2, 7 as described with reference to and illustrated in FIG. 8, wherein heating means comprising heating elements 41 are arranged within the heat insulated casing 2, 7. More specifically, according to the embodiment of the present invention illustrated in FIGS. 8 and 10, the heating elements 41 are arranged in an interior of the heat insulating portion 7, and may be arranged in (e.g., embedded in) the material(s) constituting the heat insulating portion 7. It is to be understood that not all of the components that are indicated by reference numerals in FIG. 8 are indicated by reference numerals in FIG. 10.

Just as FIG. 9, FIG. 10 illustrates a situation in which the heat insulated casing 2, 7 has been removed from the pressure vessel of the press apparatus and placed in a container 50 arranged to accommodate the heat insulated casing 2, 7. The container 50 may comprise several interconnected parts, as indicated in FIG. 10, or may be constituted by a single piece or part.

As illustrated in FIG. 10, the furnace chamber 18, which is partly enclosed by the heat insulating portion 7 of the heat insulated casing 2, 7, and which includes the furnace 14 and the load compartment 19, and the pressure medium circulation flow generator 15 may also be removably arranged in the pressure vessel, such that also those components may be at least temporarily removed from the pressure vessel. However, possibly only the heat insulated casing 2, 7 may be removably arranged in the pressure vessel, such that only the heat insulated casing 2, 7 may be at least temporarily removed from the pressure vessel, and not, even though illustrated in FIG. 10, the furnace chamber 18, the furnace 14, the load compartment 19 and the pressure medium circulation flow generator 15. In addition to the heat insulated casing 2, 7, the bottom insulating portion 4 and possibly the flow generator 13 and the pressure medium guiding passage or conduit 12 (not shown in FIG. 10; cf. FIGS. 7 and 8) may also be removably arranged in the pressure vessel, such that also those components may be at least temporarily removed from the pressure vessel.

Thus, FIG. 10 illustrates an example where the heating of the at least a part or portion of the heat insulated casing 2, 7 can be carried out while the heat insulated casing 2, 7 is removed from the pressure vessel 1, 8, 9, for example when the heat insulated casing 2, 7 is placed in the container 50 illustrated in FIG. 10. According to the embodiment of the present invention illustrated in FIG. 10, the heating of the at least a part or portion of the heat insulated casing 2, 7 can be carried out using heating means comprising heating elements 41 arranged in an interior of the heat insulating portion 7, such as described in the foregoing with reference to FIG. 8.

The container 50 could include or be coupled to an electric power supply (e.g., a battery or a power grid), and may permit for conveying power to the heating elements 41, for example by means of wiring and/or cables (not shown in FIG. 10) that may be comprised in the container 50 and that may be connected to the heating elements 41. Further, the container 50 may include wiring and/or cables for connection to one or more temperature sensors, such as, for example, one or more thermocouples or the like, which may be arranged such that it or they can sense temperature at for example the heating elements 41.

Thus, in accordance with the embodiment of the present invention illustrated in FIG. 10, subsequently to removing the heat insulated casing 2, 7 from the pressure vessel, the heat insulated casing 2, 7 may be placed in the container 50. The heating of the at least a part or portion of the heat insulated casing 2, 7 using the heating elements 41 is carried out while the heat insulated casing 2, 7 is placed in the container 50. Subsequently to carrying out the heating of the at least a part or portion of the heat insulated casing 2, 7 using the heating elements 41, the heat insulated casing 2, 7 may be removed from the container 50, and subsequently the heat insulated casing 2, 7 may be arranged in the pressure vessel. Treatment of the article(s) using the press apparatus may then be carried out.

FIG. 11 illustrates a heat insulated casing 2, 7 similar to the heat insulated casing 2, 7 described with reference to and illustrated in FIG. 7. However, in contrast to the heat insulated casing 2, 7 described with reference to and illustrated in FIG. 7, the heat insulated casing 2, 7 illustrated in FIG. 11 does not comprise any heating means (e.g., heating elements) arranged within the heat insulated casing 2, 7 (but it could). It is to be understood that not all of the components that are indicated by reference numerals in FIG. 7 are indicated by reference numerals in FIG. 11. Also, the article 5 illustrated in FIG. 7 is not illustrated in FIG. 11.

Just as FIGS. 9 and 10, FIG. 11 illustrates a situation in which the heat insulated casing 2, 7 has been removed from the pressure vessel of the press apparatus and placed in a container 50 arranged to accommodate the heat insulated casing 2, 7. The container 50 may comprise several interconnected parts, as indicated in FIG. 11, or may be constituted by a single piece or part.

As illustrated in FIG. 11, the furnace chamber 18, which is partly enclosed by the heat insulating portion 7 of the heat insulated casing 2, 7, and which includes the furnace 14 and the load compartment 19, and the pressure medium circulation flow generator 15 may also be removably arranged in the pressure vessel, such that also those components may be at least temporarily removed from the pressure vessel. However, possibly only the heat insulated casing 2, 7 may be removably arranged in the pressure vessel, such that only the heat insulated casing 2, 7 may be at least temporarily removed from the pressure vessel, and not, even though illustrated in FIG. 11, the furnace chamber 18, the furnace 14, the load compartment 19 and the pressure medium circulation flow generator 15. In addition to the heat insulated casing 2, 7, the bottom insulating portion 4 and possibly the flow generator 13 and the pressure medium guiding passage or conduit 12 (not shown in FIG. 11; cf. FIGS. 7 and 8) may also be removably arranged in the pressure vessel, such that also those components may be at least temporarily removed from the pressure vessel.

According to the embodiment of the present invention illustrated in FIG. 11, heating means comprising heating elements 42 arranged in the container 50 such that when the heat insulated casing 2, 7 is placed in the container 50, the heating elements 42 can be used to heat at least a part or portion of the heat insulated casing 2, 7. According to the embodiment of the present invention illustrated in FIG. 11, the heating elements 42 are arranged within an interior of side walls (or a side wall) of the container 50. Only some of the heating elements 42 are indicated by reference numeral 42 in FIG. 11. It is to be understood that the number of heating elements in FIG. 11 is exemplifying, and that the number of heating elements may be smaller or larger than illustrated in FIG. 11.

In accordance with the embodiment of the present invention illustrated in FIG. 11, the container 50 may have closure means (e.g., comprising a lid) 51, which can close or open the container 50, and which may permit closing the container 50 when the heat insulated casing 2, 7 has been placed in the container 50. The container 50 could for example include or be coupled to an electric power supply (e.g., a battery or a power grid) for conveying power to the heating elements 42. Further, the container 50 may include wiring and/or cables for connection to one or more temperature sensors, such as, for example, one or more thermocouples or the like, which may be arranged such that it or they can sense temperature at for example the heating elements 42.

Thus, in accordance with the embodiment of the present invention illustrated in FIG. 11, subsequently to removing the heat insulated casing 2, 7 from the pressure vessel, the heat insulated casing 2, 7 may be placed in the container 50. The heating of the at least a part or portion of the heat insulated casing 2, 7 using the heating elements 42 is carried out while the heat insulated casing 2, 7 is placed in the container 50. Subsequently to carrying out the heating of the at least a part or portion of the heat insulated casing 2, 7 using the heating elements 42, the heat insulated casing 2, 7 may be removed from the container 50, and subsequently the heat insulated casing 2, 7 may be arranged in the pressure vessel. Treatment of the article(s) using the press apparatus may then be carried out.

FIG. 12 is a schematic, in part sectional, side view of a system according to an embodiment of the present invention. The system comprises a press apparatus 90 and heating means 43, and will in the following be referred to as the system 43, 90. The system 43, 90 illustrated in FIG. 12 is similar to the system 41, 90 illustrated in FIG. 7, and the same reference numerals in FIGS. 7 and 12 denote the same or similar components, having the same or similar function. It is however to be understood that not all of the components that are indicated by reference numerals in FIG. 7 are indicated by reference numerals in FIG. 12. Compared to the system 41, 90 illustrated in FIG. 7, the system 43, 90 illustrated in FIG. 12 does not include any heating elements 41 (but it might).

Just as in FIG. 7, the arrows within the pressure vessel 1, 8, 9 in FIG. 12 indicate exemplifying flows of pressure medium within the pressure vessel 1, 8, 9 in use of the press apparatus 90, e.g., during treatment of the article(s) 5 using the press apparatus 90, such as, for example, during a cooling phase of a treatment cycle. Prior to carrying out treatment of the article(s) 5 using the press apparatus 90, there may be no flow of pressure medium in the pressure vessel 1, 8, 9 (e.g., no flow of pressure medium in the pressure vessel 1, 8, 9 as indicated by the arrows within the pressure vessel 1, 8, 9 in FIG. 12), and the pressure medium might even not yet have been introduced into the pressure vessel 1, 8, 9.

The heating means 43 in the system 43, 90 illustrated in FIG. 12 is constituted by a cooling medium circuit 43 provided on the outer surface of a wall of the pressure vessel 1, 8, 9. The cooling medium circuit 43, which is only very schematically illustrated in FIG. 12, may extend along at least a portion of the outer surface. The cooling medium circuit 43 may for example comprise one or more channels, conduits or tubes, etc., and may be arranged so as to be in connection with the outer surface of the outer wall of the pressure vessel 1, 8, 9. The cooling medium circuit 43 may be arranged to run parallel to an axial direction of the pressure vessel 1, 8, 9, as indicated in FIG. 12. In alternative or in addition, the cooling medium circuit 43 could for example be running helically or spirally around the outer surface of the outer wall of the pressure vessel 1, 8, 9.

The cooling medium circuit 43 may be configured to circulate a cooling medium therein. An exemplifying flow of cooling medium in the cooling medium circuit 43 provided on the outer surface of the wall of the pressure vessel 1, 8, 9 is indicated in FIG. 12 by the arrows on the outside of the pressure vessel 1, 8, 9. Although not shown in FIG. 12, the cooling medium circuit 43 could in addition provide a flow of cooling medium on (and/or through) one or more of the end closures 8, 9. The cooling medium may for example comprise water, but another or other types of cooling medium are possible. The cooling medium may be arranged to cool the walls of the pressure vessel 1, 8, 9 to protect the walls from detrimental heat building up during operation of the pressure vessel 1, 8, 9 or the press apparatus (e.g., during treatment or a treatment cycle). The preheating—i.e. the heating of at least a part or portion of the heat insulated casing 2, 7 carried out prior to carrying out the treatment of the article(s) using the press apparatus, may be effected by means of the cooling medium circuit 43. Specifically, the heating of the at least a part or portion of the heat insulated casing 2, 7 that is performed prior to carrying out the treatment of the article(s) using the press apparatus may comprise heating the cooling medium, and circulating the heated cooling medium in the cooling medium circuit 43 during a selected period of time. The heating of the cooling medium may be carried out such that the heated cooling medium includes an amount of thermal energy such that by transfer of thermal energy from the heated cooling medium to the wall of the pressure vessel 1, 8, 9 during the circulation of the heated cooling medium in the cooling medium circuit 43 during the selected period of time, whereby thermal energy is transferred to the interior of the pressure vessel, the at least a part or portion of the heat insulated casing 2, 7 is heated such that any amount of moisture present in or on the at least a part or portion of the heat insulated casing 2, 7 is reduced.

Thus, the heating means for carrying out the preheating may comprise cooling medium in the cooling medium circuit 43 provided at the outer surface of the wall of the pressure vessel 1, 8, 9, which cooling medium has been heated.

Heating of at least a part or portion of the heat insulated casing 2, 7 by means of the cooling medium circuit 43 may preferably be combined with any other means for carrying out the preheating disclosed herein, such as described with reference to any of FIGS. 2-11, such as by means of heating elements 41 (and/or the furnace 14) and/or heating elements 42.

On the outer surface of the outer walls of the pressure vessel 1, 8, 9, and possibly on the cooling medium circuit 43, pre-stressing means 45 may be provided. The pre-stressing means are only very schematically illustrated in FIG. 12. The pre-stressing means 45 may for example be provided in the form of wires (e.g., made of steel) wound in a plurality of turns so as to form one or more bands, and preferably in several layers, around the outer surface of the outer walls of the pressure vessel 1, 8, 9 and possibly around the cooling medium circuit 43, as indicated in FIG. 12. The pre-stressing 45 means may be arranged for exerting radial compressive forces on the pressure vessel 1, 8, 9.

The heating of the cooling medium may for example be carried out such that the temperature of the cooling medium is in a range from (about) 40° C. to (about) 150° C., or from (about) 40° C. to (about) 120° C. In case pre-stressing means are provided in the form of wires wound in a plurality of turns so as to form one or more bands around the outer surface of the outer walls of the pressure vessel 1, 8, 9 and around the cooling medium circuit 43, it may be desired or required for the cooling medium not to exceed a certain temperature. This is due to any relaxation of the wires of the pre-stressing means may depend on temperature of the wires and tension in the wires due to the winding thereof around the outer surface of the outer walls of the pressure vessel 1, 8, 9 and around the cooling medium circuit 43.

Each or any of the cooling medium circuit 43 and the pre-stressing 45 may be implemented in any of the embodiments of the present invention described herein.

FIG. 13 is a schematic, in part sectional, side view of a system according to an embodiment of the present invention. The system comprises a press apparatus 90 and heating means 41, and will in the following be referred to as the system 41, 90. The system 41, 90 illustrated in FIG. 13 is similar to the system 41, 90 illustrated in FIG. 7, and the same reference numerals in FIGS. 7 and 13 denote the same or similar components, having the same or similar function. Compared to the system 41, 90 illustrated in FIG. 7, the system 41, 90 illustrated in FIG. 13 additionally comprises one or more getter materials, schematically indicated at 36 in FIG. 13, are arranged within the pressure vessel 1, 8, 9. The pressure medium may comprise one or more gases, and the getter material(s) 36 are arranged within the pressure vessel 1, 8, 9 so as to be exposed to the pressure medium during the treatment of the article(s) 5 using the press apparatus 90. The getter material(s) 36 are configured to trap or remove particles of one or more selected gases from the pressure medium. The one or more selected gases may comprise water vapor. As illustrated in FIG. 13, the getter material(s) 36 may for example be arranged at an end of the load compartment 19 (e.g., an upper end thereof). However, other positions of the getter material(s) are contemplated, such as, for example, at the other end of the load compartment 19 (e.g., a lower end thereof). The getter material(s) may for example be arranged at one or both ends of the load compartment 19. The getter material(s) may for example be positioned in one or more pressure medium permeable holders such as cartridges, which for example may be suspended or mounted in the load compartment 19 by means of attachment means such as screws or the like. The getter material(s) 36 may for example comprise or be constituted by Ti, e.g., a plurality of Ti elements or particles, such as Ti chips or a Ti foil. Ti-based getter materials may be especially useful for removing oxygen-containing gases from a gas phase within the pressure vessel 1, 8, 9. However, other getter material(s) may in alternative or in addition be used.

In alternative or in addition to providing the getter material(s) 36 as a separate component in the pressure vessel 1, 8, 9, as illustrated in FIG. 13, one or more of the components in the pressure vessel 1, 8, 9 may at least in part be made of the getter material(s). For example, a part or portion of the furnace chamber 18 or some element comprised in the furnace chamber 18 could comprise the getter material(s). As mentioned in the foregoing, the load compartment 19 may be defined or formed by the interior of a load basket. According to one example, the load basket could be made wholly or partly by getter material(s), such as Ti.

In alternative or in addition, the load basket could be arranged to receive a holder or fixture for getter material(s).

The getter material(s) 36 may be replaced after a certain number of treatment cycles have been carried out using the press apparatus 90. In alternative or in addition, the getter material(s) 36 may be purified or regenerated after a certain number of treatment cycles have been carried out using the press apparatus 90, e.g., by subjecting the getter material(s) 36 to vacuum treatment, for example by means of removing the getter material(s) 36 from the pressure vessel 1, 8, 9 and treating the getter material(s) 36 in a vacuum furnace. The getter material(s) 36 could in alternative or in addition be purified or regenerated by performing one or more vacuum phases of a treatment cycle. Purifying or regenerating the getter material(s) 36 may be less costly compared to replacing the getter material(s) 36.

One or more getter materials may be implemented in any of the embodiments of the present invention described herein.

In conclusion, a method for a press apparatus is disclosed. The press apparatus comprises a pressure vessel including a heat insulated casing, within which at least one article is arrangeable. The press apparatus is configured to subject the at least one article to treatment. The method comprises, prior to carrying out the treatment of the at least one article using the press apparatus, heating at least a part or portion of the heat insulated casing using at least one heating means such that any amount of moisture present in or on the at least a part or portion of the heat insulated casing is reduced. Subsequently to the heating of the at least a part or portion of the heat insulated casing, the treatment of the at least one article using the press apparatus is carried out. A system comprising the press apparatus and the at least one heating means is also disclosed.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

What is claimed is:

1. A method for a press apparatus, the press apparatus comprising a pressure vessel arranged to hold a pressure medium therein during use of the press apparatus, the pressure vessel comprising an end closure, the press apparatus further comprising a heat insulated casing arranged within the pressure vessel, the heat insulated casing at least partly enclosing a furnace chamber and being arranged so that the pressure medium can enter and exit the furnace chamber, the heat insulated casing comprising a heat insulating portion that at least partly encloses the furnace chamber, and a housing at least partly enclosing the heat insulating portion, wherein a treatment region, arranged to accommodate at least one article, is at least in part defined by the furnace chamber, and the press apparatus is configured to subject the at least one article to treatment, wherein the heat insulated casing comprises at least one pressure medium guiding passage formed between at least a portion of the housing and at least a portion of the heat insulating portion, and the at least one pressure medium guiding passage is arranged to, during use of the press apparatus, guide the pressure medium that has exited the furnace chamber towards the end closure such that the pressure medium having exited the at least one pressure medium guiding passage can be guided in proximity to an inner surface of a wall of the pressure vessel, the method comprising:
prior to carrying out the treatment of the at least one article using the press apparatus, heating at least a part or portion of the heat insulated casing using at least one heating means such that any amount of moisture present in or on the at least a part or portion of the heat insulated casing is reduced; and
subsequently to the heating of the at least a part or portion of the heat insulated casing, carrying out the treatment of the at least one article using the press apparatus.

2. A method according to claim 1, wherein by heating the at least a part or portion of the heat insulated casing, moisture present in or on the at least a part or portion of the heat insulated casing is released from one or more surfaces of the at least a part or portion of the heat insulated casing, the method further comprising, subsequently to the heating of the at least a part or portion of the heat insulated casing and prior to the carrying out the treatment of the at least one article using the press apparatus:
withdrawing gas resulting from the release of moisture present in or on the at least a part or portion of the heat insulated casing from the heat insulated casing or from the pressure vessel.

3. A method according to claim 1, wherein the heating of the at least a part or portion of the heat insulated casing using at least one heating means comprises:
using at least one heating element, operable to generate heat at a selected output power, to heat the at least a part or portion of the heat insulated casing at the selected output power of the at least one heating element and during a selected period of time, wherein the output power of the at least one heating element and the period of time are selected such that any amount of moisture present in or on the at least a part or portion of the heat insulated casing is reduced.

4. A method according to claim 3, wherein the at least one heating element is used to heat at least one of: at least a portion of the heat insulating portion, or at least a portion of the housing, at the selected output power of the at least one heating element and during the selected period of time, such that any amount of moisture present in or on one or more of the at least a portion of the heat insulating portion or the at least a portion of the housing is reduced.

5. A method according to claim 3, wherein the at least one heating element is arranged within or inside the heat insulated casing.

6. A method according to claim 5, wherein the press apparatus comprises a pressure medium flow generator configured to generate a flow of the pressure medium in the furnace chamber and the at least one pressure medium guiding passage;
wherein the method further comprises:
concurrently with or after using at least one heating element to heat the at least a part or portion of the heat insulated casing, operating the pressure medium flow generator to generate the flow of the pressure medium in the furnace chamber and the at least one pressure medium guiding passage.

7. A method according to claim 5, wherein the at least one heating element is arranged in an interior of the heat insulating portion.

8. A method according to claim 5, wherein the at least one heating element is arranged in at least a part of the at least one pressure medium guiding passage.

9. A method according to claim 5, wherein the at least one heating element is arranged in at least one part of the furnace chamber.

10. A method according to claim 3, wherein the heat insulated casing is removably arranged in the pressure vessel, such that the heat insulated casing can be at least temporarily removed from the pressure vessel, wherein the carrying out of the heating of the at least a part or portion of the heat insulated casing using the at least one heating element comprises:
removing the heat insulated casing from the pressure vessel;
carrying out the heating of the at least a part or portion of the heat insulated casing using the at least one heating element while the heat insulated casing is removed from the pressure vessel; and
subsequently to carrying out the heating of the at least a part or portion of the heat insulated casing using the at least one heating element, arranging the heat insulated casing in the pressure vessel.

11. A method according to claim 10, further comprising:
subsequently to removing the heat insulated casing from the pressure vessel, placing the heat insulated casing in a container arranged to accommodate the heat insulated casing, wherein the at least one heating element is arranged in or on the container such that when the heat insulated casing is placed in the container, the at least one heating element can be used to heat the at least a part or portion of the heat insulated casing, the method further comprising:
carrying out the heating of the at least a part or portion of the heat insulated casing using the at least one heating element while the heat insulated casing is placed in the container; and
subsequently to carrying out the heating of the at least a part or portion of the heat insulated casing using the at least one heating element, removing the heat insulated casing from the container and subsequently arranging the heat insulated casing in the pressure vessel.

12. A method according to claim 1, wherein the press apparatus comprises a pressure medium flow generator configured to generate a flow of the pressure medium in the furnace chamber and the at least one pressure medium guiding passage, and wherein the heating of the at least a part or portion of the heat insulated casing using at least one heating means comprises:
introducing heated pressure medium into the pressure vessel; and
operating the pressure medium flow generator to generate a flow of the heated pressure medium in the furnace chamber and the at least one pressure medium guiding passage during a selected period of time;
wherein the heated pressure medium includes an amount of thermal energy such that by transfer of the thermal energy from the heated pressure medium to the at least a part or portion of the heat insulated casing during the passage of the heated pressure medium in the furnace chamber and the at least one pressure medium guiding passage and during the selected period of time, the at least a part or portion of the heat insulated casing is heated such that any amount of moisture present in or on the at least a part or portion of the heat insulated casing is reduced.

13. A method according to claim 12, wherein the heated pressure medium comprises the pressure medium having been used in the press apparatus during a previous occasion of treatment using the press apparatus.

14. A method according to claim 1, wherein the outer surface of a wall of the pressure vessel is provided with a cooling medium circuit extending along at least a portion of the outer surface, the cooling medium circuit being configured to circulate a cooling medium therein, wherein the heating of the at least a part or portion of the heat insulated casing using at least one heating means comprises:
heating the cooling medium; and
circulating the heated cooling medium in the cooling medium circuit during a selected period of time;
wherein the heating of the cooling medium is carried out such that the heated cooling medium includes an amount of thermal energy such that by transfer of thermal energy from the heated cooling medium to the wall of the pressure vessel during the circulation of the heated cooling medium in the cooling medium circuit during the selected period of time, whereby thermal energy is transferred to the interior of the pressure vessel, the at least a part or portion of the heat insulated casing is heated such that any amount of moisture present in or on the at least a part or portion of the heat insulated casing is reduced.

15. A system comprising:
a press apparatus comprising:
a pressure vessel arranged to hold a pressure medium therein during use of the press apparatus, the pressure vessel comprising an end closure; and
a heat insulated casing arranged within the pressure vessel, the heat insulated casing at least partly enclosing a furnace chamber and being arranged so that the pressure medium can enter and exit the furnace chamber, the heat insulated casing comprising a heat insulating portion, which at least partly encloses the furnace chamber, and a housing at least partly enclosing the heat insulating portion, wherein a treatment region, arranged to accommodate at least one article, is at least in part defined by the furnace chamber, and the press apparatus is configured to subject the at least one article to treatment, wherein the heat insulated casing comprises at least one pressure medium guiding passage formed between at least a portion of the housing and at least a portion of the heat insulating portion, and the at least one pressure medium guiding passage is arranged to, in use of the press apparatus, guide the pressure medium that has exited the furnace chamber towards the end closure such that the pressure medium having exited the at least one pressure medium guiding passage can be guided in proximity to an inner surface of a wall of the pressure vessel;
the system further comprising:
at least one heating means configured to, prior to carrying out the treatment of the at least one article using the press apparatus, heat at least a part or portion of the heat insulated casing such that any amount of moisture present in or on the at least a part or portion of the heat insulated casing is reduced;
wherein the press apparatus is configured to, subsequently to the heating of the at least a part or portion of the heat insulated casing, carry out the treatment of the at least one article using the press apparatus.

16. A system according to claim 15, wherein the pressure medium comprises one or more gases, and wherein one or more getter materials are arranged within the pressure vessel so as to be exposed to the pressure medium during the treatment of the at least one article using the press apparatus, wherein the one or more getter materials are configured to trap or remove particles of one or more selected gases from the pressure medium, the one or more selected gases comprising water vapor.

17. A system according to claim 15, further comprising:
a sensor configured to sense an amount of moisture in the pressure medium within the heat insulated casing during treatment.

18. A system according to claim 17, wherein the sensor is configured to sense an amount of moisture in the pressure medium within the furnace chamber.
